(19) United States
(12) Patent Application Publication
(10) Pub. No.: US 2007/0076255 A1
(43) Pub. Date: Apr. 5, 2007

(54) Image output apparatus, image output method, and image display method

(75) Inventors: Mitsuhiro Hamashima, Tokyo (JP); Jun Yoshida, Tokyo (JP); Naoji Shibasaki, Tokyo (JP); Kazuo Negishi, Tokyo (JP)

Correspondence Address: ROSSI, KIMMS & McDOWELL LLP., P.O. BOX 826, ASHBURN, VA, 20146-0826, US

(73) Assignee: DAI NIPON PRINTING CO., LTD, shinjuku-ku (JP)

(21) Appl. No.: 10/576,232

(22) PCT Filed: Oct. 14, 2004
(86) PCT No.: PCT/JP04/15166

§ 371 Date: Jul. 14, 2006

(30) Foreign Application Priority Data
Oct. 15, 2003 (JP) 2003-355220
Nov. 10, 2003 (JP) 2003-379438
Nov. 10, 2003 (JP) 2003-380219

(51) Int. Cl. G06K 15/00

(52) U.S. Cl. 358/1.16; 358/1.9

(57) ABSTRACT

When an image data to be displayed is held in a cache memory 602, an image output apparatus 101 reads out the image data from the cache memory 602 and displays the read image data (S61, S65). When the image data is not held in the cache memory 602, the image output apparatus reads out the image data from a recording medium 603 and displays the read image data (S63, S62, S65). After the user selects a date folder 1202, the image output apparatus 103 searches and extracts image data and displays a list of the image data 1222 pertaining to the date folder (step 1104). The image output apparatus 103 assigns image data to be printed out to other image output apparatus 103 and requests image data printout. The other image output apparatus 103 convey printed items to the image output apparatus having received the order (apparatus having requested the printout) using a conveyer 215.

### TECHNICAL FIELD

The present invention relates to an image output apparatus and the like which can print out images photographed with a digital camera, images read by a scanner, image data recorded on a recording medium which has been brought in, image data stored in the apparatus in advance, as well as images obtained through composition and/or editing of the above described images.

### BACKGROUND ART

In recent years, image output apparatuses (digital photograph printing devices, etc.) have been placed and used in stores and on streets as street terminals (KIOSK terminals). These image output apparatuses read images photographed with a digital camera or the like, image data recorded on a recording medium, and the like, and perform image editing, image composition, printout, etc. (refer to, for example, [Patent Document 1] and [Non-Patent Document 1]).

Image output apparatuses are placed in identification photograph photographing corners near train stations, amusement facilities such as game arcades, and the like. A user brings a recording medium on which image data taken with the user's own digital camera are recorded and loads these images into the image output apparatus, or takes a photograph on site. Then, the user can perform an image editing process and the like as required, and specify output size, the number of outputs, etc. so as to output high-resolution color prints, which the user can take home.

In addition, image display and image selection are performed in the image output apparatus as follows. When a recording medium on which images are recorded is inserted into a media reader, the image output apparatus generally displays a list of images by displaying a plurality of thumbnail images or the like. Then, the user selects an image to be printed out from the image list.

In addition, there is also an image printing system that has a plurality of printers and sequentially assigns items to be printed to these printers.

Patent Document 1: Japanese Patent Application Laid-Open (kokai) No. 2002-46324

Non-Patent Document 1: Dai Nippon Printing Co., Ltd., “Dejitaru-camera no susume”, [online], [searched on Dec. 1, 2002], Internet <URL: http://www.digicamates.com/ susume/index.html>

### DISCLOSURE OF THE INVENTION

### PROBLEMS TO BE SOLVED BY THE INVENTION

However, because the conventional image output apparatus accesses a recording medium to read image data each time an image data is displayed or printed out, quick display or print out of the image data is difficult. This is problematic in that, the user (operator, etc.) experiences annoyance and inconvenience when operating the apparatus.

For example, when a list of image data is displayed, multiple images cannot be displayed quickly as in the case of flipping through a photo album. Therefore, waiting time is generated during a page-switching process (processing of operations such as “go to next page” or “back to previous page”), which results in an increase in the overall processing time. Moreover, there is a problem in that since desired image data cannot be selected quickly, the user may stop the use of the image output apparatus, whereby potential print orders may be lost, and ultimately the usage rate and the operation rate of the apparatus decrease.

Furthermore, an image list is displayed in the conventional image output apparatus according to photographing dates (not, however, separated by the dates) or according to the alphabetical order of file names. In addition, the images are displayed in a predetermined, specific sequence or by a predetermined, specific display method, such as the number of displayed images being fixed to 10 images in a 2×5 layout. Thus, the conventional image output apparatus has a problem in that the selection of images to be printed is complicated, and the processing time increases because images that are not to be printed are handled.

For example, the conventional image output apparatus has the following problem. In the case where a large number of images (for example, 100 or more images) are stored in the recording medium, even if the user wishes to process only the images shot during a certain period, the images shot before and after the period may be displayed.

In addition, an image cannot be displayed in the conventional image output apparatus through specification of the photographing date. This is problematic in that the user (user, operator, etc.) experiences annoyance and inconvenience.

In addition, the conventional image output apparatus that has a plurality of printers assigns printing jobs to the printers according to a predetermined sequence (for example, from printer 1 to printer n) every time a printing order is received. Thus, after repeated printing operations, the operation rates of the printers differ greatly from one another, as does the amounts of remaining printing materials. This is problematic in that the timings for replenishing printing materials vary and only a certain printer (for example, printer 1) is used frequently, leading to failure, etc.

Moreover, the conventional image output apparatus has the following problem. When the same image data is printed using different printers, the reproducibility of colors and tones may differ from one another due to differences between individual printers, differences between printing material lots, etc.

In addition, the conventional image output apparatus has a problem in that if printing materials in all of the printers are depleted almost simultaneously, the entire system may stop.

Moreover, the conventional image output apparatus has the following problem. When printed items printed by a plurality of printers are ejected into a plurality of removal openings, the labor of removing the printed items from the plurality of removal openings is placed on the user, and the user's printed items become mixed with those of others.

The present invention was achieved in view of the above-mentioned problems. An object of the present invention. is to provide an image output apparatus and the like that can enhance operability through high-speed display processing and printout processing for image data, enable users to specify display conditions, enhance operability through high-speed display processing and selection processing for image data, perform efficient, high-quality, high-speed image printout, and in addition, reduce maintenance load and workload.

Means for Solving the Problems

In order to achieve the foregoing object, a first invention is an image output apparatus comprising input element for inputting an image data from a recording medium; output element for printing out the image data; temporary storage element for reading non-displayed image data from the recording medium and holding the non-displayed image data in a temporary storage section with holding already-displayed image data; and display element for reading image data from the temporary storage section and displaying the read image data.

The image output apparatus of the first invention reads non-displayed image data from the recording medium and holds the non-displayed image data, as well already-displayed image data, in the temporary storage section. The image output apparatus reads image data from the temporary storage-section and displays the read image data.

The already-displayed image data is an image data that has already been displayed.

The non-displayed image data is an image data that has not yet been displayed and-has been read in advance from the recording medium.

The temporary storage section is a cache memory used as temporary storage element. Static random access memory (SRAM) that has a relatively high data access speed or a hard disk and the like that serves as a large-capacity memory medium can be used as the temporary storage section. The cache memory can be an internal cache that is embedded in a central processing unit (CPU), an external cache that is installed outside of the CPU, etc. In addition, the cache memory can be a hard disk or the-like serving as a large-capacity memory medium.

The temporary storage medium, such as SRAM and the hard disk, has a higher data access speed than a recording medium reading device (media reader).

The recording medium (media) is a recording medium for recording image data; for example, Smart Media, CompactFlash® cards (CF cards), floppy® disks, PC cards, optical disks (CD-ROM, etc.) and the like.

The image output apparatus holds the image data in the temporary storage section or deletes the image data, according to an order of priority and predetermined limitations (predetermined rules, setting data, etc.).

With regards to the order of priority, for example, the image data of the next screen to be displayed may be prioritized. Detailed image data corresponding to a selected simplified image data or a simplified image data near the selected image data may also be prioritized.

The predetermined limitations can be set by specifying the maximum number of image data (the maximum number of already-displayed image data, the maximum number of non-displayed image data, the total sum of these image data, etc.) that can be held in the temporary storage section, the maximum data capacity thereof, and the like.

The image output apparatus of the first invention holds in cache memory image data that had been displayed relatively recently and is very likely to be displayed again. The image data is read from the cache memory rather than the recording medium and displayed. Thus, the image data can be displayed quickly and efficiently.

In addition, the image output apparatus predicts user operations, reads image- data that is very likely to be displayed in the future from the recording medium in advance, and holds the image data in the cache memory. The image data is read from the cache memory rather than the recording medium and displayed. Thus, the image data can be displayed quickly and efficiently.

A second invention is an image output apparatus comprises input element for inputting an image data from a recording medium; temporary storage element for holding in a temporary storage section an image data that has been designated to be printed out; and output element for reading the image data from the temporary storage section and printing out the read image data.

When the image data to be printed out is designated from a displayed list (reduced image data, etc.), the image output apparatus of the second invention reads the image data (detailed image data, etc.) from a cache memory for display or from the recording medium in advance, prior to the printout process. Then, the image data apparatus converts the read data into an image data for printout and holds the image data in a cache memory for printing. When the printout process is performed, the image output apparatus reads the image data from the temporary storage section and prints out the read image data.

In addition, the image output apparatus holds the image data for printout in the temporary storage section or deletes the image data, according to predetermined limitations (predetermined rules, setting data, etc.).

The predetermined limitations can be set by specifying the maximum number of image data (the maximum number of image data for printout) that can be held in the temporary storage section, the maximum data capacity thereof, and the like.

In addition, the image output apparatus can be configured so as to automatically calculate the predetermined limitations based on the capacity of the temporary storing section and the number of printing devices (printers, etc.).

For the image data that has been designated to be printed out, the image output apparatus of the second invention holds the image data for printout in the cache memory in advance, prior to the printout process. The image data are read from the cache memory rather than the recording medium and printed out. Thus, the printout process can be performed quickly and efficiently.

A third invention is an image display method performed by an image output apparatus that prints out image data read out from a recording medium, comprising reading non-displayed image data from the recording medium and holding the non-displayed image data in a temporary storage section with holding already-displayed image data; and reading an image data from the temporary storage section and displaying the read image data.

The third invention is an invention related to the image display method performed by the image output apparatus of the first invention.

A fourth invention is an image display method performed by an image output apparatus that prints out image data read out from a recording medium, comprising holding in a temporary storage section image data that is designated to be printed out; and reading an image data from the temporary storage section and printing out the read image data.

The fourth invention is an invention related to the image output method performed by the image output apparatus of the second invention.

A fifth invention is an image output apparatus comprising input element for inputting an image data from a recording medium; display condition specifying element for displaying selection items for each display condition and specifying the display condition through selection of a selection item; display element for displaying the image data based on the display conditions; and output element for printing out the image data.

The image output apparatus of the fifth invention acquires image data and attached information (photographing date, file name, folder name, etc.) thereof, and displays selection items (date folders, etc.) for each display condition (by date, etc.) The display conditions are specified by selection of the selection items. The image output apparatus displays image data corresponding to the specified display conditions (a list of thumbnail images, etc.), and when an image data is selected, prints out the selected image data.

In addition, the image output apparatus may display the display conditions (dates, etc.) indicated by selection items, at least one representative image data corresponding to the display conditions indicated by the selection items, information (number of image data, etc.) related to the image data corresponding to the display conditions indicated by the selection items, etc., while relating them to the selection items.

In addition, the image output apparatus can sequentially switch the image data pertaining to the selection items and display the image data as the representative image data.

In addition, the image output apparatus may display selection items on a calendar.

Display conditions are the conditions regarding image data that the user wishes to display in a list; for example, date, year, month, week, hour, time zone, etc. of image data creation or image photographing.

Selection items are items used to specify display conditions; for example, date folders displayed by date to specify the date.

The image output apparatus of the fifth invention displays a list of image data based on the display conditions specified by the user (photographing dates, etc.). Thus, the user can easily find desired image data by specifying the display conditions. In addition, the image output apparatus displays only image data meeting the display conditions in the list. Thus, image data not required by the user are not processed, thereby enhancing quick processing and operability.

A sixth invention is an image display method performed by an image output apparatus that prints out image data read out from a recording medium, comprising displaying selection items for each display condition and specifying the display condition through selection of a selection item; and displaying the image data based on the display conditions.

The sixth invention is an invention related to the image output method performed by the image output apparatus of the fifth invention.

A seventh invention is an image output apparatus comprising input element for inputting image data; printing element for printing out image data using a plurality of printing devices; and assigning element for assigning the image data to the plurality of printing devices, where the assigning element preferentially assigns the image data to be printed to the printing device that has printed out the least number of image data.

An eighth invention is an image output apparatus comprising input element for inputting image data; printing element for printing out image data using a plurality of printing devices; and assigning element for assigning the image data to the plurality of printing devices, where the assigning element assigns the same image data to the same printing device.

A ninth invention is an image output apparatus comprising input element for inputting image data; printing element for printing out the image data using a plurality of printing devices; and assigning element for assigning the image data to the plurality of printing devices, where the assigning element assigns a smaller percentage of image data to a certain printing device than to other printing devices.

The image output apparatus of the seventh invention to the ninth invention assigns inputted image data to a plurality of printing devices (printers, etc.), and the respective printing devices perform printout.

The image output apparatus of the seventh invention preferentially assigns the image data to be printed out to the printing device that has printed out the least number of image data.

The image output apparatus of the eighth invention assigns the same image data to the same printing device.

The image output apparatus of the ninth invention assigns a smaller percentage of image data to a certain printing device than to other printing devices.

When order details are received, the image output apparatus of the seventh invention preferentially assigns image data to the printing devices in ascending order of the number of printed out image data. Therefore, the operation rates of printers are almost equal even after repeated printing orders, and the amounts of remaining printing materials do not differ between printers. Thus, situations where the timings for replenishing printing materials vary and certain printers are more frequently used, thereby leading to failure, etc., can be avoided.

When the order details are received, the image output apparatus of the eighth invention assigns the same image data to the same image output apparatus (printer). The same image data are printed by the same printer, and thus, situations where the reproducibility of colors and tones may differ due to differences between individual printers, differences between printing material lots, etc., can be avoided.

When the order details are received, the image output apparatus of the ninth invention assigns a smaller percentage of image data to a certain printing device than to other printing devices. Thus, situations where the printing materials in all of the printers are depleted almost simultaneously, thereby stopping the entire system, can be avoided.

A 10^{th} invention is a image output apparatus comprising input element for inputting image data; printing element for printing out the image data using a plurality of printing devices; assigning element for assigning the image data to the plurality of printing element; a plurality of removal openings corresponding to the printing devices; and a printed item conveying device for conveying printed items to a predetermined removal opening.

In addition, the device can be configured so that an open and close flap of the predetermined removal opening is opened and those of all other removal openings are closed.

The image output apparatus of the 10^{th} invention assigns inputted image data to a plurality of printing devices (printers, etc.), and the respective printing devices perform printout. Each image output apparatus conveys the printed item to the predetermined removal opening using the conveyor device (belt conveyer, etc.).

If the removal opening is provided for each printing device, the image output device opens the open and close flap of the predetermined removal opening (the removal opening of a printer to which the printed items are conveyed or the removal opening of a printer having assigned the image data) and closes the open and close flaps of the other removal openings (the removal opening of the printer from which the printed items are conveyed or the removal opening of the printer to which the image data is assigned).

Even when image data are assigned to a plurality of printers, the user can remove the printed items from one printed item removal opening. Thus, the workload placed on the user can be reduced and mix-ups between the user's printed items and those of others can be prevented.

An 11^{th} invention is an image output method performed by an image output apparatus that prints out inputted image data, comprising printing out image data using a plurality of printing devices; assigning the image data to the plurality of printing devices; and conveying printed items to a predetermined removal opening among removal openings provided for each printing device.

The 11^{th} invention is an invention related to the image output method performed by the image output apparatus of the 10^{th} invention.

A 12^{th} invention is a program that enables a computer to function as any one of the image output apparatuses of the 1^{st} invention, the 2^{nd} invention, the 5^{th} invention, and the 7^{th} to the 10^{th} invention.

A 13^{th} invention is a recording-medium on which the. program that enables a computer to function as any one of the image output apparatus of the 1^{st} invention, the 2^{nd} invention, the 5^{th} invention, and the 7^{th} to-the 10^{th} invention is recorded.

The foregoing program can be held in a recording medium such as a CD-ROM and distributed or can be transmitted and received via a communication network.

Effects of the Invention

According to the present invention, an image output apparatus and the like that can enhance operability through high-speed display processing and printout processing for image data, enable users to specify display conditions, enhance operability through high-speed display processing and selection processing for image data, perform efficient, high-quality, high-speed image printout, and in addition, reduce maintenance load and workload, can be provided.

### BRIEF DESCRIPTION OF THE DRAWINGS

FIG. 1 Block diagram showing a configuration of an image output apparatus 101.

FIG. 2 Outer perspective view of the image output apparatus 101.

FIG. 3 Hardware configuration diagram of the image output apparatus 101.

FIG. 4 Flowchart showing an overall operation of the image output apparatus 101.

FIG. 5 Flowchart showing an operation of the image output apparatus 101 related to an image display process.

FIG. 6 Diagram showing the process flow of the image output apparatus 101 in the image display process.

FIG. 7 Diagram showing the flow of a process for temporary holding already-displayed image data (image data that has already been displayed).

FIG. 8 Diagram showing the flow of a process for temporary holding non-displayed image data (image data that has been read in advance).

FIG. 9 Diagram showing the process flow of the image output apparatus 101 in an image data printout process.

FIG. 10 Block diagram showing a configuration of an image output apparatus 102.

FIG. 11 Flowchart showing an operation of the image output apparatus 102 related to an image data acquisition process and a display process.

FIG. 12 Diagram showing the process flow of the image output apparatus 102 in the image data acquisition process and display process.

FIG. 13 Diagram showing an example of selection items (folders) by day, by week, by month, and by year.

FIG. 14 Explanatory diagram showing a process for switching representative images related to a date folder 1401 (selection item).

FIG. 15 Diagram showing an example of a display condition specification screen 1501.

FIG. 16 Block diagram showing a configuration of an image output apparatus printing system 100 (an image output apparatus 103).

FIG. 17 Outer perspective view of the image printing system 100 (the image output apparatus 103).

FIG. 18 Side view of the image printing system 100 (the image output apparatus 103).

FIG. 19 Front view of the image printing system 100 (the image output apparatus 103).

FIG. 20 Hardware configuration diagram of the image output apparatus 103.

FIG. 21 Flowchart showing an operation of the image output apparatus 103.

FIG. 22 Diagram showing order details and printing steps.

FIG. 23 Diagram showing order details and printing steps.

FIG. 24 Diagram showing order details and printing steps.

FIG. 25 Diagram showing order details and printing steps.

FIG. 26 Diagram showing order details and printing steps.

FIG. 27 Flowchart showing an operation of the image output apparatus 103 related to a printed item conveying process.

### 100: IMAGE PRINTING SYSTEM

101: Image output apparatus (a first embodiment)

102: Image output apparatus (a second embodiment)

103: Image output apparatus (a third embodiment)

105: Network (connection line)

111: Image data reading and writing means

112: Image editing and compositing means

113: Material database

114: Printing means

115: Order details input means

116: Charging means

117: Display means

118: Temporary storage means

119: Display condition specifying means

121: Image data assigning means

122: Communication means

123: Printed item conveying means

133: Recording medium (media)

134: Printed item

201: Monitor screen

202: Media insertion opening

205: Printed item removal opening

207: Cable through-hole

208: Printed item conveying hole

211: Computer

212: Printer

213: Cable

214: Guide

215: Conveyer

216: Open and close flap of removal opening

217: Lock

301: Control section

302: Storage section

306: Various media reading and writing section (1 - n)

307: Monitor

311: Printer

313: Printed item conveying section

314: Communication control section.

601: CPU

602: Cache memory

603: Recording medium

604, 605: Image data

901: CPU

902: Cache memory for display

903: Cache memory for printing

904: Recording medium

905: Image data

906: Image data for display

907: Image data for printout

1201: Display condition specification screen

1202: Date folder (selection item)

1203: Date

1204: Representative image

1205: Number of image data

1501: Display condition specification screen

1502: Date folder

1503: Calendar

### BEST MODE FOR CARRYING OUT THE INVENTION

Preferred embodiments of the image output apparatus and the like according to the present invention will be described in detail hereinafter, with reference to the attached drawings. Constituent elements in the following description and attached drawings having generally the same functions and constructions are given the same reference numerals. Thus, redundant descriptions are omitted.

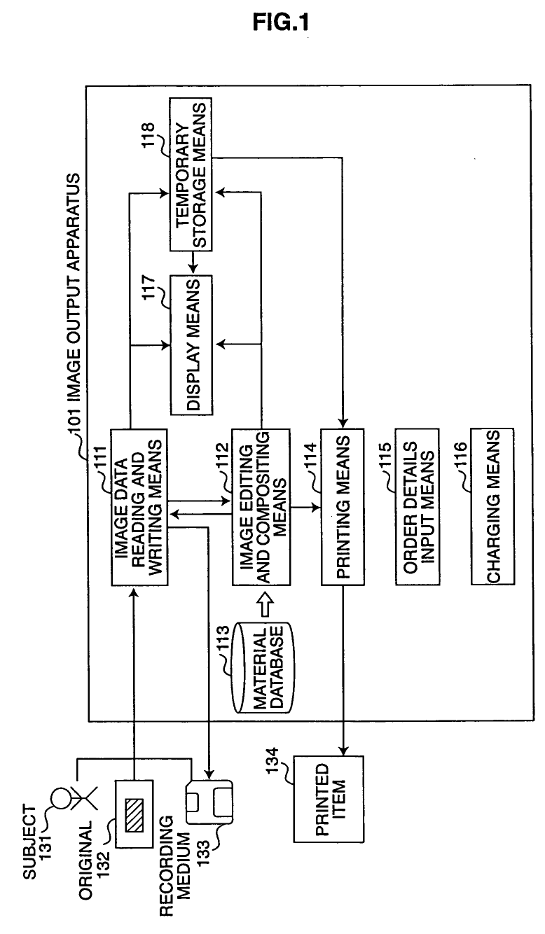

First, a configuration of an image output apparatus 101 according to a first embodiment of the present invention is described with reference to FIG. 1.

FIG. 1 is a block diagram showing the configuration of the image output apparatus 101.

The image output apparatus 101 includes an image data reading and writing means 111, an image editing and compositing means 112, a material database 113, a printing means 114, an order details input means 115, a charging means 116, a display means 117, a temporary storage means 118, etc.

The image data reading and writing means 111 acquires image data by photographing a subject 131 (user) with an imaging device such as a digital camera or the like, reading an original 132 with an original reading device such as a scanner device, or reading the image data from a recording medium 133 (media) to which the image data was recorded in advance. In addition, the image data reading and writing means 111 can record on the recording medium 133 image data created by the image output apparatus 101.

The recording medium 133 is, for example, Smart Media, Compact Flash® cards (CF card), floppy® disks, PC cards, optical disks (CD-ROM, etc), and the like.

The image editing and compositing means 112 comprises an interactive-type interface for interactively compositing and editing one or more image data which has been inputted or selected. Examples of compositing and editing are processing, such as doodling and stamping, clipping of image data, size-change, pasting of clipped image onto another image, and the like. Image data used for processing, compositing and editing can be material image data, frame image data, and the like which are in a material database 113.

The printing means 114 is a high-resolution color printer. No limitation is imposed on the type of the printing system, and the printing means 114 may be of a sublimation-type or an inkjet-type. A printed item 134 is a printout of an identification photograph obtained through photographing, or a photograph, a sticker, a postcard, etc. obtained from a digital camera image or the like.

The user selects the details of an order for an item to be output by use of an order details input means 115. Selectable items are print mode selection (designation as to, for example, whether normal output of actual image data is performed; whether an index printout is performed; whether a postcard print is performed; whether a sticker print is performed; whether an identification photograph print is performed; etc.). Furthermore, when the normal output of actual image data and the like is selected, thumbnail images are displayed, and designation of the image to be printed when plural frames of image data are inputted (monitor display of thumbnail images and image selection in the case where digital camera images are output), specification of the number of prints and print sizes, and the like are made. Before an image is output, the user can designate one or more image data and process, composite, and edit the image data.

Various pointers such as a touch-panel which is integrated with a display means, such as a CRT or a liquid crystal panel, a keyboard, a mouse, or a trackball can be used as the order details input means 115.

The charging means 116 activates respective functions of the image output apparatus 101 according to the amount of money inserted in advance.

The display means 117 is a display device such as a CRT, a liquid crystal panel, or the like that displays image data. The display means 117 reads out image data from the image data reading and writing means 111, the image editing and compositing means 112, or the temporary storage means 118 and displays the read image data.

The temporary storage means 118 temporarily holds already-displayed image data, image data that has been read in advance, image data for printout, and the like.

The image output apparatus 101 reads out the image data from the temporary storage means 118 and performs a display process, a printout process, etc.

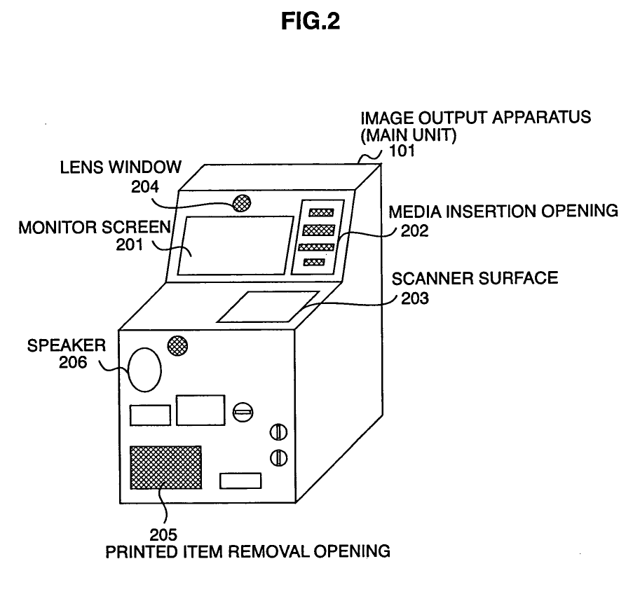

Next, the outer structure of the image output apparatus 101 is described with reference to FIG. 2.

FIG. 2 is an outer perspective view of the image output apparatus 101.

A monitor screen 201, which is a monitor with a touch-panel or the like, is placed on the front surface of the upper part of the image output apparatus 101 (main unit). The monitor screen 201 functions as a display means 117 for displaying an operation guide, the operation state, a read image, an edited and processed image, and the like.

A media insertion opening 202 is provided beside the screen of the monitor screen 201. A scanner surface 203 for reading and digitalizing an image of a printed item is placed in a horizontal part which separates the upper part and the lower part of the image output apparatus 101. In addition, a lens window 204 for photographing a subject (user, etc.) with a digital camera or the like is placed above the screen of the monitor screen 201.

These media insertion opening 202, scanner surface 203, and window 204 constitute a part of the image data reading and writing means 111.

The media insertion opening 202 is a reception section for various media (such as Smart Media, CompactFlash® cards (CF cards), floppy® disks, PC cards, and optical disks (CD-ROM, etc.)). A floppy® disk insertion opening, a CD-ROM insertion opening, a PC card insertion opening, a Smart Media insertion opening, a CompactFlash® insertion opening, and the like are placed collectively in one location. In addition, the respective main units (not shown) of the reading devices (media readers) corresponding to each of the abovementioned recording media types are placed within the main unit of the image output apparatus 101.

In addition, each insertion opening can comprise an open and close cover (shutter). In this case, the image output apparatus 101 can be set so that the recording medium cannot be removed during processing or the recording medium cannot be removed until the charging processing or the collection of fees is completed, by controlling the opening and closing of the open and close flap.

A printed item removal opening 250, a speaker 206, and the like are installed in the lower part of the image output apparatus 101. In addition, a fee insertion opening (coin insertion opening and bill insertion opening), a return lever, a return opening, a receipt removal opening, a maintenance key, a door open and close key, and the like are also provided herein.

The printed item removal opening 250 constitutes a part of the printing means 114. The user receives the printed item ejected from the printed item removal opening 205 after instructing the execution of printing, such as by touching a touch-panel button.

The speaker 206 reproduces a warning sound, an acknowledgment sound, an operation guide message, voice, BGM, sound effects, and the like during operation or during stand-by.

In addition, a personal computer including a control section for controlling each constituent part, a power supply box for performing voltage conversion, an uninterruptible power source device for preventing damage to the CPU, hard disk, etc. of the control section during a power outage, and the like (not shown) are installed within the main unit of the image output apparatus 101.

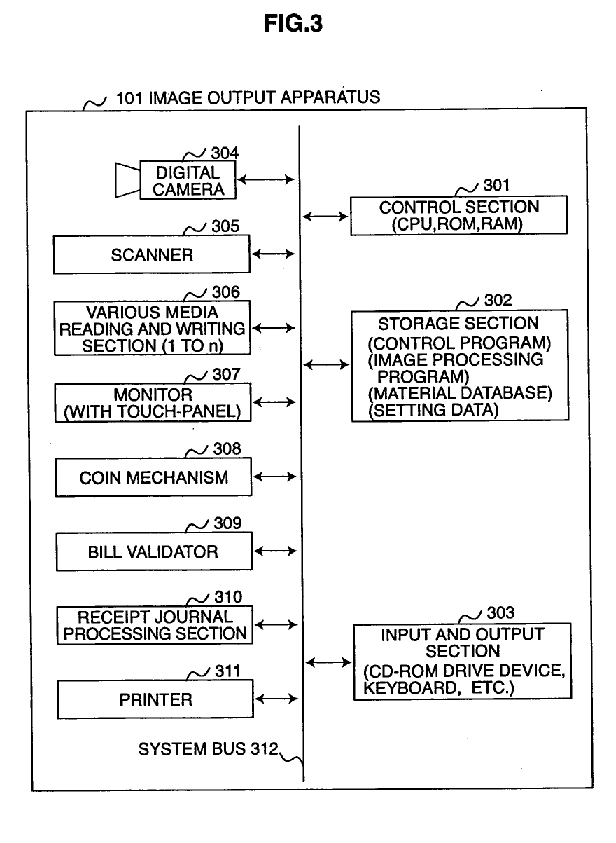

Next, the hardware configuration of the image output apparatus 101 is explained with reference to FIG. 3.

FIG. 3 is a hardware configuration diagram of the image output apparatus 101.

In the image output apparatus 101, a control section 301, a memory section 302, an input and output section 303, a digital camera 304, a scanner 305, various media reading and writing sections 306 (1 to n), a monitor 307 (with a touch-panel), a coin mechanism 308, a bill validator 309, a receipt journal processing section 310, a printer 311, and the like are connected via a system bus 312.

The control section 301 comprises a CPU, ROM, RAM, and the like. The control section 301 drive-controls each device connected thereto via the system bus 312, according to a program stored in the memory section 302, which is a hard disk or the like serving as a large-capacity memory medium.

Programs for drive-controlling each constituent part, for example, a reading and writing program corresponding to each recording medium, a charging program, and the like, are stored in the memory section 302. In addition, as a part of the input editing and compositing means 112, an image processing program for editing and processing an inputted or selected image and an image processing program for creating thinned data so as to prepare index data are stored in the memory section 302. Further, as a part of the order details input means 115, a program for displaying an interactive-type menu on the monitor 307, setting printing conditions for the printing means 114, and instructing the start of printing is stored in the memory section 302. Furthermore, a material database 113 to which image data, such as frames used for image composition, background images, line illustration images for coloring, etc. are stored, various setting data, and the like are also stored in the memory section 302.

The program codes are read by the control section 301 as required, transferred to the RAM, and read by the CPU so as to be executed as various means.

Further, a portion of the RAM can be functioned as the above-described temporary storage means 118.

In addition, the memory of the control section 301 or the memory section 302 can temporarily hold information such as data necessary for processing, image data, and the like.

The input and output section 303 (CD-ROM drive device, keyboard, mouse, etc.) are used to update programs and information stored in the ROM of the control section 301 and the memory section 302, as well as at the time of settings, such as the operation settings of the image printing system and equipment settings. The setting is performed by switching the main unit section to a management mode with the maintenance key, inserting a CD-ROM for updates into the input and output section 303, and overwriting data. Alternatively, the setting is performed by entering setting data.

The digital camera 304, the scanner 305, and the various media reading and writing sections 306 (1 to n) perform image data acquisition and input. These sections correspond to the image data reading and writing means 111.

A sequence of operations, from print mode selection and reading of original image data, processing, compositing, and editing to the output of a printed item can be performed by the user through selecting and touching the touch-panel buttons displayed on the monitor 307 according to the operation guide displayed on this monitor 307. The monitor 307 corresponds to the abovementioned display means 117.

The coin mechanism 308, the bill validator 309, and the receipt journal processing section 310, which correspond to the charging means 116, receive coin insertion and bill insertion and issues receipts.

The printer 311, which corresponds to the printing means 114, performs the image printout process.

The system bus 312 is a path which mediates the transfer of control signals, data signals, etc. between the sections and the devices.

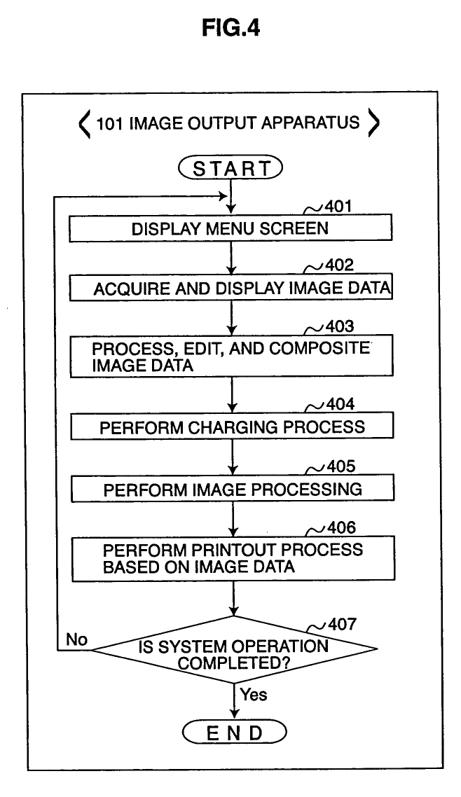

Next, an operation of the image output apparatus 101 is described with reference to FIG. 4.

FIG. 4 is a flowchart showing an overall operation of the image output apparatus 101.

The image output apparatus 101 (control section 301) displays a menu screen showing service details, procedures, guides, etc. and requests that the user make selections (Step 401).

The image output apparatus 101 acquires image data and displays the image data on the monitor (Step 402).

When inputting image data, the user can select a method, such as reading from a recording media, reading from a scanner, or photographing a subject by an imaging device (digital camera and the like).

The image output apparatus 101 performs processing, editing, compositing, etc. of the image data based on instructions from the user (Step 403). Processing, editing, and compositing of the image are, for example, compositing input image data together, compositing with a frame image, compositing with existing images and the like, coloring, inputting text, moving, enlarging and reducing, creating postcard data, and the like.

The image output apparatus 101 performs a charging process and a receipt issuing process according to the details of the user's order (output mode (photograph print, sticker print, index print, postcard print, etc.), number of prints and the like) (Step 404).

The image output apparatus 101 performs image processing, such as color correction, resizing, trimming, layout, composition of text and logos, and the like (Step 405). Then, the image output apparatus 101 holds the image-processed image data in the memory, hard disk device, or the like, transfers the image data to a printer device which is in an output-ready state, and performs the printout process (Step 406).

When continuing the operation of the image printing system 100 (No, in Step 407), the image output apparatus 101 repeats the processes in Step 401 to Step 407.

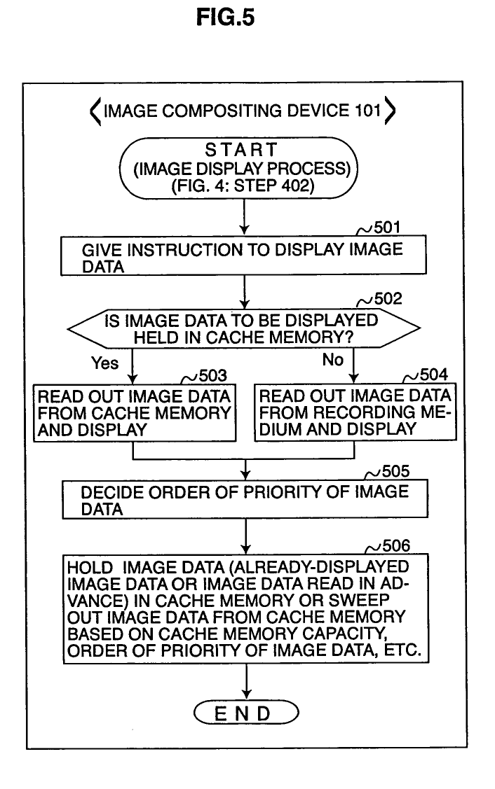

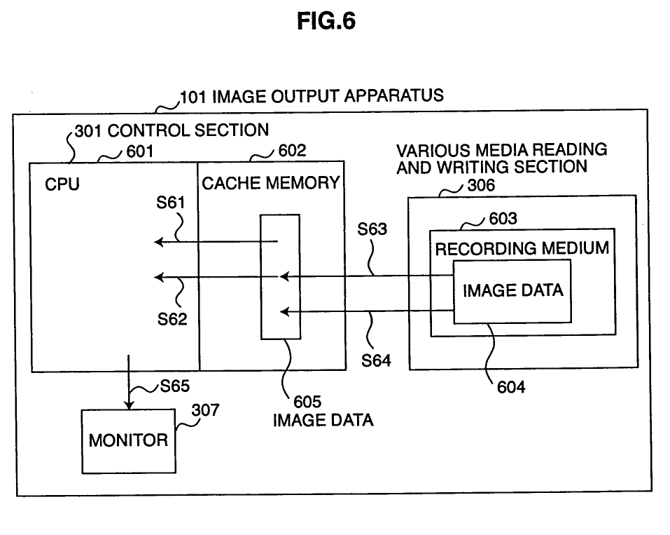

Next, an operation of the image output apparatus 101 related to an image display process (FIG. 4: Step 402) is described with reference to FIG. 5 and FIG. 6.

FIG. 5 is a flowchart showing the operation of the image output apparatus 101 related to an image display process.

FIG. 6 is a diagram showing the process flow of the image output apparatus 101 in the image display process.

As shown in FIG. 6, the control section 301 of the image output apparatus 101 includes a CPU 601 and a cache memory 602, serving as a temporary storage section. The various media reading and writing section 306 reads out image data 604 from a recording medium 603. The monitor 307 displays the image data.

Static random access memory (SRAM) with a relatively high data access speed, a hard disk with a large storage capacity, and the like can be used as the cache memory 602.

The image output apparatus 101 (control section 301) receives an instruction to display image data through user operation (Step 501).

When the image data is held in the cache memory 602 (Yes, in Step 502), the image output apparatus 101 reads out the image data from the cache memory 602 to the CPU 601. Then, the image data is transferred to video RAM (VRAM) and displayed on the monitor 307 (Step 503, S61 and S65).

When the image data is not held in the cache memory 602 (No, in Step 502), the image output apparatus 101 reads out the image data from the recording medium 603. Then, the image data is transferred to VRAM and displayed on the monitor 307 (Step 504, S62 and S65).,

The image output apparatus 101 (control section) decides an order of priority in which image data recorded in the recording medium is held in the cache memory (Step 505).

The image output apparatus 101 (control section 301) holds the image data in the cache memory or sweeps out the image data from the cache memory, based on predetermined limitations (cache memory capacity, etc.) and the order of priority of the image data (Step 506, S63 and S64).

The control section 301 temporarily holds the image data 604 in the cache memory 602. Image data 605 held in the cache memory 602 include already-displayed image data (image data that has already been displayed) (S63), non-displayed image data (image data that has been read in advance) (S64), and the like.

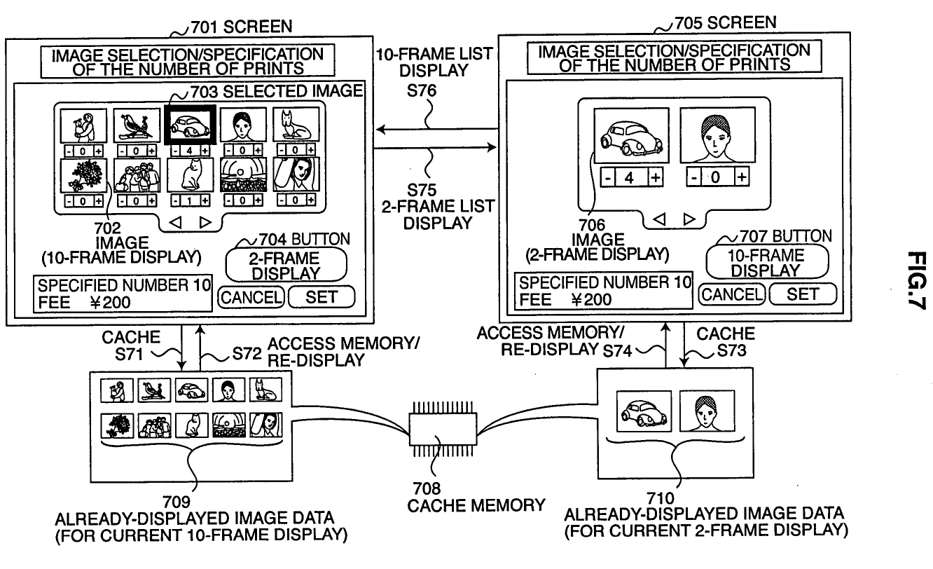

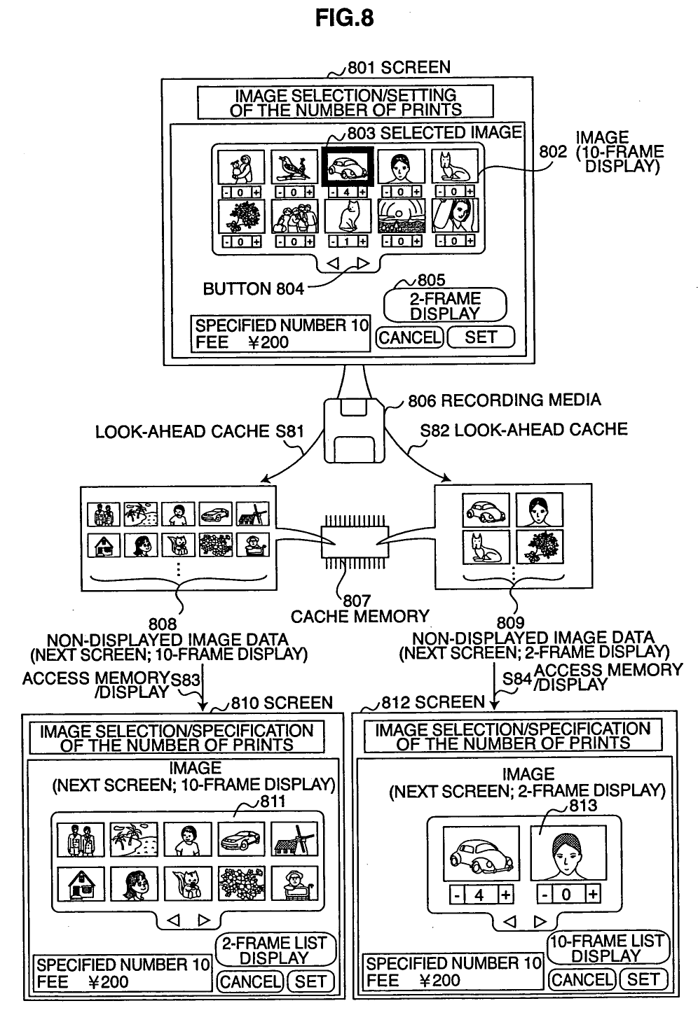

Next, an example of the image display process (FIG. 4: Step 402) is described with reference to FIG. 7 and FIG. 8.

The following descriptions are made under the assumption that 10-frame listed images are displayed based on simplified image data (thumbnail image data or reduced image data) within an image data file, and two-frame listed images are displayed based on detailed image data (ordinary image data, actual image data, enlarged image data) within the image data file. In this case, for example, an exchange image file format (EXIF) that holds simplified image data and actual image data in one file can be used as the format type of the image data file.

FIG. 7 is a diagram showing the flow of a process for temporary holding already-displayed image data (image data that has already been displayed).

The image output apparatus 101 displays 10-frame listed images 702 on a monitor screen 701 and holds the images in a cache memory 708 as already-displayed-image data 709 (for the current 10-frame screen) (S71).

In addition, the image output apparatus 101 displays 2-frame listed images 706 on a monitor screen 705 and holds the images in the cache memory 708 as already-displayed image data 710 (for the current 2-frame screen) (S73).

Subsequently, when the same list screen is displayed again, the image output apparatus 101 accesses the cache memory 708 to read out the already-displayed image data 709 or the already-displayed image data 710, and re-displays the 10-frame listed images 702 or the 2-frame listed images 706 on the monitor (S72 and S74).

The user can switch between the 10-frame list screen 701 and the 2-frame list screen 705 by touching a button 704 “2-frame display” or a button 707 “10-frame display” (S75 and S76). In this case, as described above, if the list screen had already been displayed, the image output apparatus 101 reads the already-displayed image data from the cache memory 708 and displays the image data.

The order of priority in which the image data are held in the cache memory can be decided to be the reverse of the order in which the image data were displayed (FIG. 5: Step 505).

As described above, the image output apparatus holds in cache memory the image data that had been displayed relatively recently and are very likely to be displayed again. The image data are read from the cache memory rather than the recording medium and displayed. Thus, the image data can be displayed quickly and efficiently.

FIG. 8 is a diagram showing the flow of the process for temporary holding non-displayed image data (image data that has been read in advance).

After displaying a 10-frame list screen 802 on a monitor screen 801, the image output apparatus 101 reads non-displayed image data 808 (10-frame listed image data for the next and subsequent screens) in advance from a recording medium 806 and holds the image data in a cache memory 807 (S81).

For a selected image-803 (an image selected by the user) and images displayed near the selected image 803 in the 10-frame listed images 802 on the monitor screen 801, the image output apparatus 101 reads 2-frame listed images- 809 corresponding to these images from the recording medium 806 in advance, and holds them in the cache memory 807 (S82).

The image output apparatus 101 may be configured such that when no image is selected by the user, a predetermined image in the listed images (for example, the image in the upper left corner) is processed as the selected image.

Next, if the user touches button 804 “ | >(Next page)”, the image output apparatus 101 accesses the cache memory 807 and reads the non-displayed image data 808 (for 10-frame display for the next screen). Then, the image output apparatus displays a 10-frame listed images 811 of the next page on a monitor screen 810 (S83).

In addition, if the user touches button 805 “2-frame display” on the screen 801, the image output apparatus 101 accesses the cache memory 807 and reads the non-displayed image data 809 (for 2-frame display for the next screen). Then, the image output apparatus 101 displays 2-frame listed images 813 on a monitor screen 812 (S84).

The order of priority in which image data read in advance from the recording medium is held in the cache memory can be decided so that, for example, detailed image data corresponding to the selected simplified image data and the simplified image data displayed in the vicinity thereof, simplified image data corresponding to the selected detailed image data and the detailed image data displayed in the vicinity thereof, or image data for the next or previous screen is prioritized (FIG. 5: Step 50).

The image output apparatus reads the image data that will very likely be displayed from the recording medium and holds the image data in the cache memory by predicting user operations. The image data are read from the cache memory rather than the recording medium and displayed. Thus, the image data can be displayed quickly and efficiently.

Caching performed in advance follows predetermined rules. For example, caching is started from on the image (reference image) designated at the time the list screen is displayed. If no image is designated, the image displayed first is regarded as the reference image. When the simplified display list screen (10-frame, etc.) is displayed, the image data for the detailed display (2-frame, etc.) are also cached at the same time.

The image output apparatus 101 may be configured such that if the caching of the image data within the screen has not been completed when the screen is switched to another, the caching process is canceled. In this case, the canceled caching process can be performed again after the next prior read process is performed.

In addition, if the amount of cached data exceeds the capacity of the cache, data already cached are deleted according to predetermined rules. For example, the oldest image data (the image data cached first) is deleted when the cache has reached maximum capacity.

In addition, in the above embodiment, 10-frame display image data is explained as simplified image and 2-frame display data is explained as detailed image data; however, the numbers of frames to be displayed are not limited to these examples.

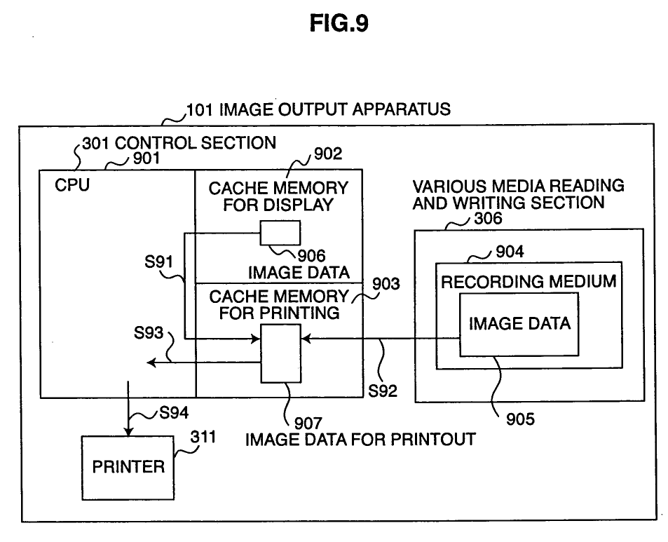

Next, an example of an image data printout process is described with reference to FIG. 9.

FIG. 9 is a diagram showing the process flow of the image output apparatus 101 in the image data printout process.

As shown in FIG. 9, the control section 301 of the image output apparatus 101 includes a CPU 901, a cache memory for display 902 used as a temporary storage section for image data for display, and a cache memory for printing 903 used as a temporary storage section for image data for printout. The various media reading and writing section 306 reads out image data 905 from a recording medium 904. The printer 311 prints out image data.

SRAM with a relatively high data access speed, a hard disk with a large storage capacity, and the like can be used as the cache memory for display 902 and the cache memory for printing 903.

When an image data is designated to be printed out by user operation, if the detailed image data corresponding to the designated image data is held in the cache memory for display 902, the image output apparatus 101 (control section 301) reads out the detailed image data 906 from the cache memory for display 902, converts the detailed image data into an image data for printout, and holds the converted image data in the cache memory for printing 903 (S91). If the detailed image data corresponding to the designated image data is not stored in the cache memory for display 902 (when a simplified image is used to instruct printout, etc.), the image output apparatus 101 (control section 301) reads out the image data from the recording medium 904, converts the image data into an image data for printout 907, and holds the converted image data in the cache memory for printing 903 (S92).

The foregoing process can be performed in advance before the actual printout process starts.

When performing the printout process, the image output apparatus 101 reads out the image data for printout 907 held in the cache memory for printing 903, and transfers the image data to a printer buffer. The transferred image data is printed out by the printer 311 (S93 and S94).

During the printout process, the image output apparatus 101 deletes image data that has already been printed out from. the cache memory for printing 903. Then, the image output apparatus 101 sequentially reads out the detailed image data that are designated to be printed out but are not held in the cache memory for printing 903, from the cache memory for display 902 (S91) or the recording medium 904 (S92), converts the image data into the image data for printout 907, and holds the converted image data in the cache memory for printing 903. When the actual printout is performed, the image data for printout 907 is read out from the cache memory 903, transferred to the printer buffer, and printed out by the printer 311 (S93 and S94).

As described above, for the image data that is designated to be printed out, the image output apparatus holds in advance the image data for printout in the cache memory before the printout process. Therefore, the image data can be read from the cache memory rather than the recording medium and printed out. Thus, the image data can be printed out quickly and efficiently.

The number of image data held in the cache memory for printing, the size of the cache, etc. may be decided automatically by the image output apparatus according to memory capacity, hard disk capacity, the number of printers, and the like.

As described above, according to the first embodiment of the present invention, the image output apparatus holds in the cash memory already-read image data, image data read in advance, image data for printout, etc. and reads out them from the cache memory rather than the recording medium. Thus, the image output apparatus can quickly perform the display process, the printout process, and the like.

The predetermined limitations, settings, and the like related to the cache memory, for example, the maximum numbers of image data for display and for printout held in the cache memory (the number of already-displayed image data, the number of image data read in advance, the number of image data for printout, the total sum of the these image data, etc.), caching level (mode), the size of image to be cached, the size of cache, and the like, can be set. This setting can be performed by the administrator of the image output apparatus or the like. The image output apparatus holds the information set by the administrator, etc. as setting data in the storage section, and accesses the storage section according to processing details so as to refer the setting data.

In addition, default values indicating standard values may be provided as the setting data, which eliminates the necessity of setting by the administrator, etc. The image output apparatus may be configured such that the entire setting data or a part thereof is stored as separate data (in a separate file) and the like, and the location of the separate data (the separate file) and the like is included in the setting data.

The maximum number of image data to be held in a cache memory can be determined as such. Therefore, even if there are limitations on memory capacity or hard disk capacity of personal computers and the like, hardware resources can be used efficiently and effectively by setting the limitations and upper limits according to the operation environment.

In addition, the maximum number of image data to be read in advance can be set. However, when the number of image data to be read is not limited, the limit can be set to be the same number as the maximum number of the image data held in the cache memory.

In addition, the caching level (mode) can also be set; for example, a quality-priority mode (processing speed is compromised to some extent to cache high-quality image data), a speed-priority mode (process speed is given priority when caching image data), and the like.

In addition, the size of image data to be cached can be also set. For example, when the set size of the image data to be cached is the same as the size of the image data displayed on the screen, the image output apparatus caches the image data as is. When the set size of the image data to be cached is smaller than the size of the image data displayed on the screen, the image output apparatus caches the image data according to the set size and enlarges the cached image data when the image data is displayed. When the set size of the image data to be cached is smaller than the size of the image data displayed on the screen, the image data is enlarged when displayed, and thus, the quality of the displayed image is degraded. However, high speed processing can be realized and the number of cashed image data can be increased.

In addition, the image output apparatus can include each means (FIG. 1, etc.) and each device (FIG. 3, etc) integrally, or a portion thereof can be separated and connected by a connection line (cable or the like, which may be wired or wireless), network (dedicated line, LAN, the Internet, etc., which may be wired or wireless).

In addition, the image output apparatus can perform guidance through screen display, and additionally, guidance through voice, video, etc.

In addition, the programs which execute the processes shown in FIG. 4 to FIG. 9, etc. can be held in a recording medium such as a CD-ROM and distributed or can be transmitted and received via a communication network.

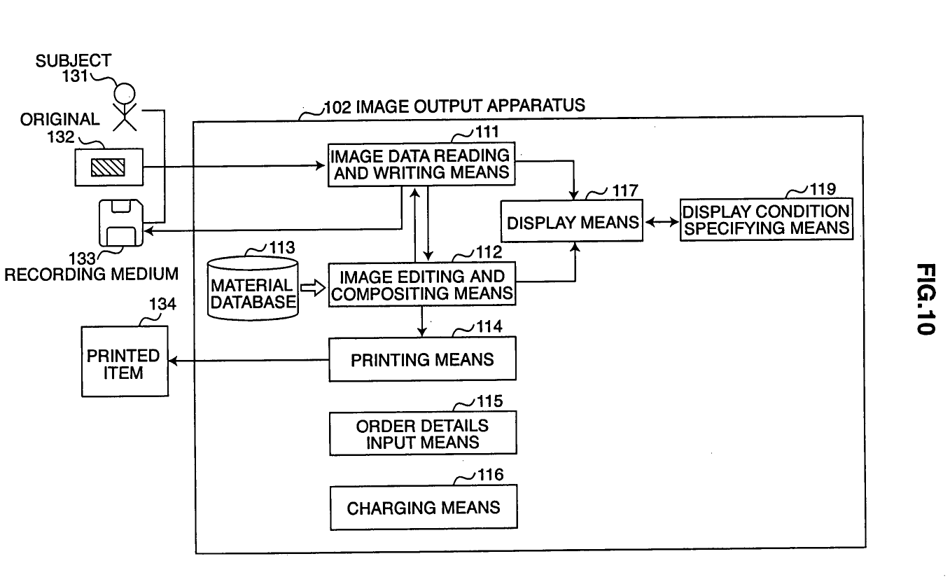

Next, an image output apparatus 102 according to a second embodiment of the present invention is described with reference to FIG. 10.

FIG. 10 is a block diagram showing a configuration of the image output apparatus 102.

The image output apparatus 102 includes an image data reading and writing means 111, an image editing and compositing means 112, a material database 113, a printing means 114, an order details input means 115, a charging means 116, a display means 117, a display condition specifying means 119, etc.

The image data reading and writing means 111, the image editing and compositing means 112, the material database 113, the printing means 114, the order details input means 115, the charging means 116, and the like shown in FIG. 10 are the same to those shown in FIG. 1. Thus, the descriptions thereof are omitted.

The display means 117 is a display device such as a CRT, a liquid crystal panel, or the like that displays image data. The display means 117 displays image data based on display conditions specified by the display condition specifying means 119.

The display condition specifying means 119 shows selection items for specifying the display conditions. The user specifies the display conditions (date, year, month, week, hour, time zone, etc. of image data creation or photographing) by selecting the selection items.

The outer perspective view, the hardware configuration, and the overall operation of the image output apparatus 102 are the same as those shown in FIG. 2, FIG. 3, and FIG. 4, respectively. Thus, the descriptions thereof are omitted.

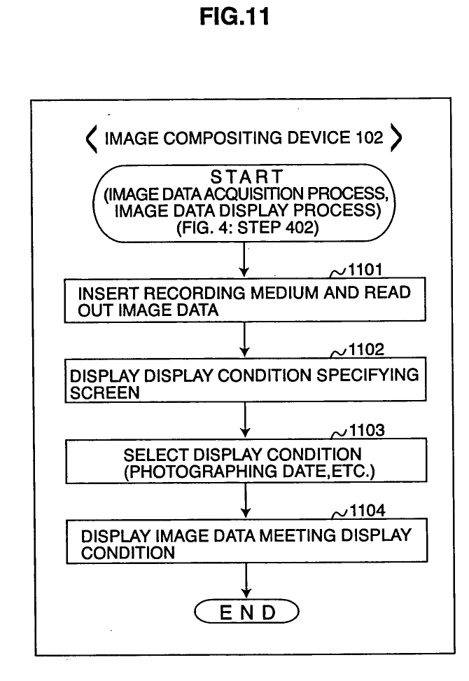

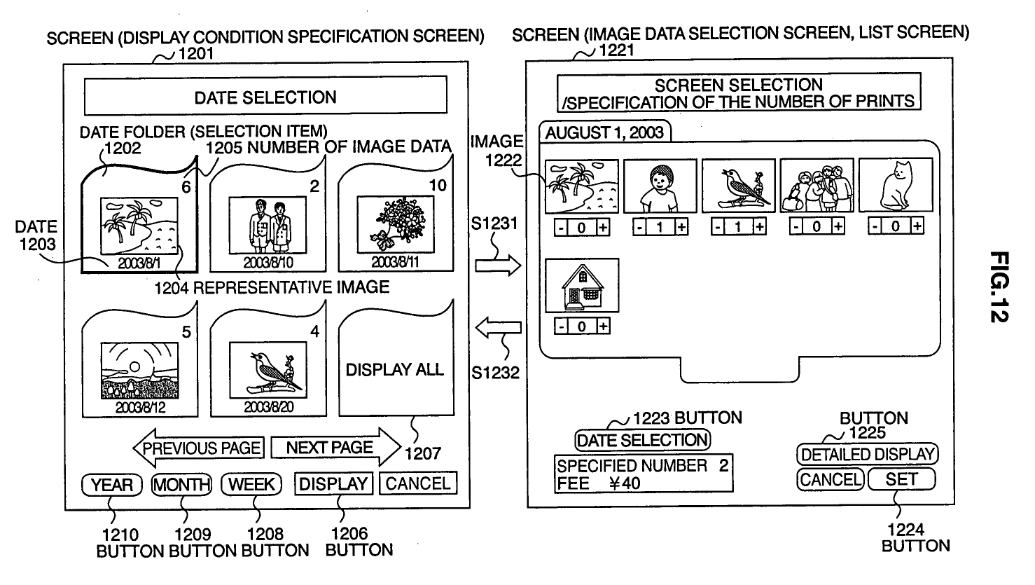

Next, an operation of the image output apparatus 102 related to an image data acquisition process and a display process (FIG. 4: Step 402) is described with reference to FIG. 11 and FIG. 12.

FIG. 11 is a flowchart showing the operation of the image output apparatus 102 related to the image data acquisition process and the display process.

FIG. 12 is a diagram showing the process flow of the image output apparatus 102 in the image data acquisition process and the display process.

When an image data is read out from a recording medium to which image data is recorded and a normal output of actual image data and the like is performed, the image output apparatus 102 displays a display condition specification screen, and the user specifies display conditions on the display condition specification screen. The image output apparatus 102 displays a list of image data based on the display conditions specified by the user. Then, the user selects image data from the list of image data and specifies the number of prints, print size, and the like. The list of image data is displayed using reduced images (thumbnail images), etc.

The image output apparatus 102 (control section 301) reads out image data (simplified image data, detailed image data, actual image data, etc.) and image management information accompanying the image data from a recording medium 133 that is inserted into a media insertion opening (Step 1101). The image management information includes the image data photographing date, the image data creation date, the file name, the folder name, and the like.

The image output apparatus 102 displays a display condition specification screen 1201 on the monitor screen (Step 1102). Date folders 1202 are displayed by date (by photographing date or creation date) as selection items for display conditions on the display condition specification screen 1201.

The date folder 1202 is displayed along with a date 1203, a representative image 1204, the number of image data 1205, and the like.

The date 1203 is the date specified by the date folder 1202 as a display condition, for example, “Aug. 1, 2003”.

The representative image 1204 is a part of an image data in the date folder 1202 (for example, the first image data of the day, etc). A reduced image may be displayed, or a plurality of images may be displayed as the representative image 1204.

The number of image data 1205 indicates the number of image data in the date folder 1202, for example, “6”.

The user specifies a display condition (a photographing date) by touching the date folder 1202 on the monitor, on the display condition specification screen 1201 (Step 1103). The user can also select a plurality of date folders 1202.

When the user touches button 1206 “Display” after specifying the display condition by selecting the date folder 1202, the image output apparatus 102 retrieves and extracts image data based on the specified display condition. Then, the image output apparatus 102 displays a list of image data 1222 that meets the display condition on an image data selection screen 1221 (list screen) (Step 1104).

When the user touches button 1224 “Set” on the monitor after selecting image data 1222 and specifying the number of printouts, the image output apparatus 102 prints out the image data. In addition, if the user touches button 1225 “Detailed display” on the monitor after selecting the image data 1222, the image output apparatus 102 displays the detailed image of the image data (not shown).

If the user touches button 1206 “Display” on the monitor, the image output apparatus 102 switches the display condition specification screen 1201 to the image data selection screen 1221 (S1231). If the user touches button 1223 “Date selection” on the monitor, the image output apparatus 102 switches the image data selection screen 1221 to the display condition specification screen 1201 (S1232).

In addition, when specification of the date is unnecessary, the user can display a list of all image data by selecting a folder 1207 “Display all”.

The image output apparatus displays images which are to be displayed in a list, in advance, by date, etc., and allows the user to make selections. In addition to date, the number of image data with the same date, and the selected image (the representative image, etc.) in this date can also be displayed. Furthermore, even after the images are displayed in a list, the user can return to the date selection screen and repeat selection. For example, the user can return to the date selection screen from the list screen and specify a date again.

Therefore, the user can easily select desired images by date. The user can also select and display the desired images intuitively, from past memory, by displaying-images by date.

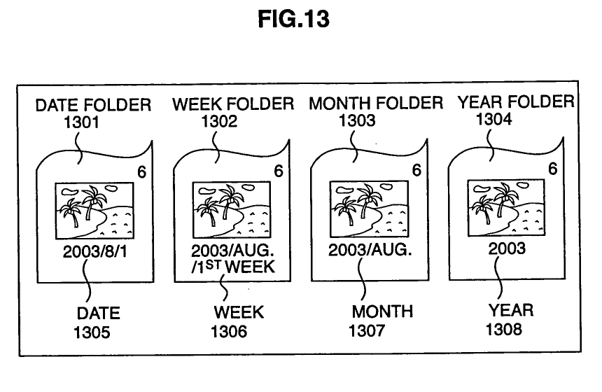

FIG. 13 is a diagram showing an example of selection items (folders) by day, by week, by month, and by year.

A date folder 1301 is a selection item by day and is displayed with a date 1305. A week folder 1302 is a selection item by week and is displayed with a week 1306. A month folder 1303 is a selection item by month and is displayed with a month 1307. A year folder 1304 is a selection item by year and is displayed with a year 1308.

In the description of the above-mentioned embodiment, the date folder is used as a selection items for specifying display conditions. However, the date is not the only display condition that can be specified. For example, if the user touches button 1208 “Week”, button 1209 “Month”, or button 1210 “Year” on the monitor, the image output apparatus displays the selection items (the week folder 1302, the month folder 1303, or the year folder 1304) by week, by month, or by year, accordingly. The user can specify a photographing year, a photographing month, a photographing week, etc. by selecting a selection item.

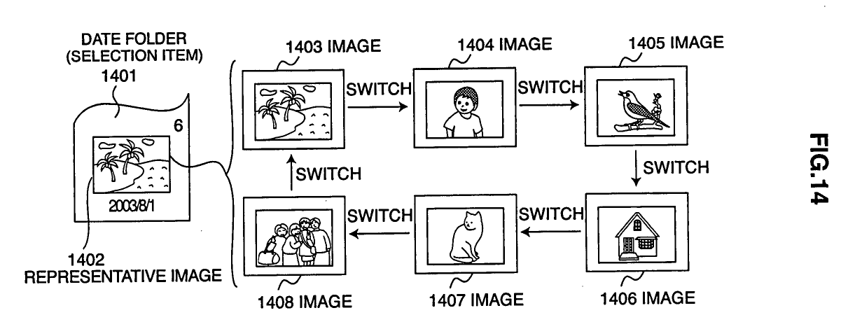

FIG. 14 is an explanatory diagram showing a switching process of the representative images related to a date folder 1401 (selection item).

The image output apparatus 102 can display a representative image along with selection items specifying the display conditions.

The user can determine the overview of image data pertaining to the selection items by viewing the representative image. Thus, the user can efficiently find desired images data, leading to the enhancement of the operability of the image output apparatus.

The image output apparatus 102 can display a fixed, predetermined image data (for example, the first image data pertaining to the selection item) as the representative image, or can also sequentially switch the image data pertaining to the selection item and display the image data (like a slide show, etc.).

As shown in FIG. 14, when displaying a date folder 1401 (a selection item), the image output apparatus 102 sequentially switches the image data 1403 to 1408 pertaining to the date folder 1401 and displays the image data as a representative image 1402.

The image output apparatus 102 may be configured in such a manner that the process of switching the representative image 1402 is automatically performed every time a predetermined time passes or when the user touches the representative image 1402 of the date folder 1401 on the monitor. In this case, the image output apparatus 102 may be also configured so that the selection of a date folder is performed when the user touches a part of the date folder other than the representative image, and the process of switching the representative image is performed when the user touches a part corresponding to the representative image.

As described above, the image output apparatus can switch and display images with the same date as such. Thus, the user can determine the content of the image data pertaining to the selection item (folder) more accurately.

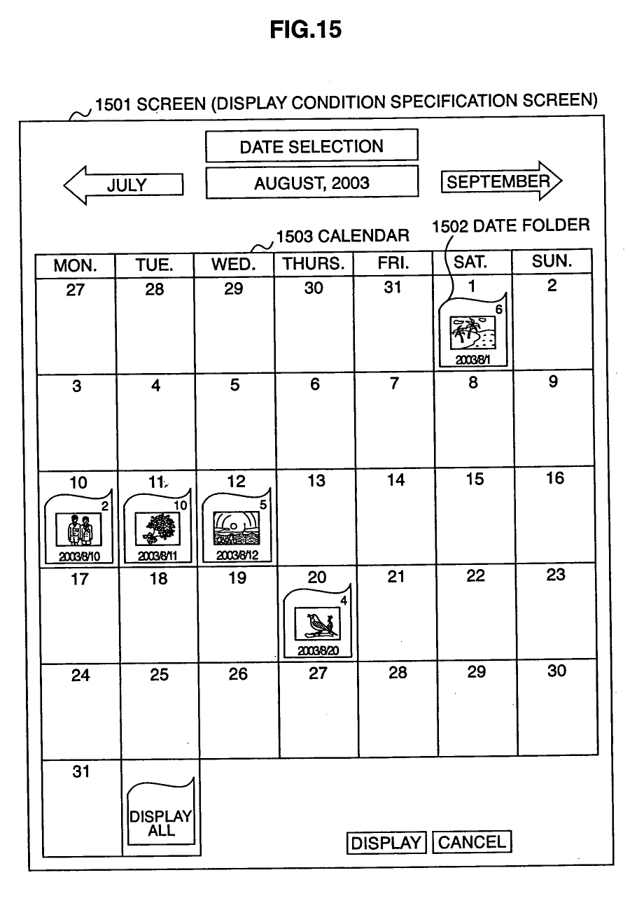

FIG. 15 is a diagram showing an example of a display condition specification screen 1501.

Although it is explained in the foregoing embodiment that the selection items specifying display conditions are displayed to be sequentially arranged on the display condition specification screen (FIG. 12, etc.), date folders 1502 (selection item) can be displayed on a calendar 1503, as shown on the display condition specification screen 1501 in FIG. 15.

In this case, the user can recognize the display conditions (date, etc.) indicated by selection items instantly from the calendar, as well as display conditions (date, etc.) displayed with the selection items. In other words, the user can intuitively select the desired date or image based on the calendar display.

The image output apparatus may be configured such that an image data list is displayed based on simplified image data (thumbnail image data, reduced image data) within an image data file, and a detailed image is displayed based on detailed image data (ordinary image data, actual image data, enlarged image data, etc.) within the image data file. In this case, for example, the exchange image file format (EXIF) which holds simplified image data and actual image data in one file or the like can be used as the format type of the image data file.

As described above, according to the second embodiment of the present invention, the image output apparatus displays an image data list based on the display conditions (photographing data, etc.) specified by the user. Thus, the user can easily find the desired image data by specifying the display conditions. In addition, the image output apparatus displays only image data meeting the display conditions in the list. Thus, image data not required by the user are not processed, thereby enhancing quick processing and operability.

In addition, the programs which execute the processes shown in FIG. 11 to FIG. 15, etc. can be held in a recording medium such as a CD-ROM and distributed or can be transmitted and received via a communication network.

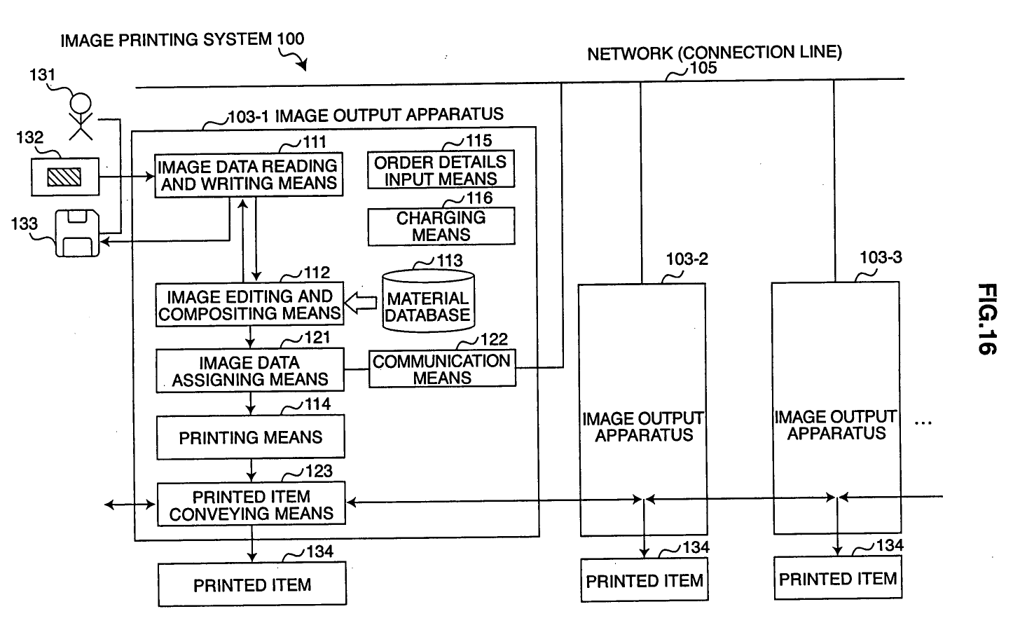

Next, the configuration of an image printing system 100 (an image output apparatus 103) according to a third embodiment of the present invention is described with reference to FIG. 16.

FIG. 16 is a block diagram showing a configuration of the image output apparatus printing system 100 (the image output apparatus 103).

As shown in FIG. 16, the image printing system 100 includes a plurality of image output apparatus 103 (103-1, 103-2, 103-3 . . . ) connected via a network (connection line) 105.

The image output apparatus 103 includes an image data reading and writing means 111, an image editing and compositing means 112, a material database 113, a printing means 114, an order details input means 115, a charging means 116, an image data assigning means 121, a communication means 122, a printed item conveying means 123, and the like.

The image data reading and writing means 111, the image editing and compositing means 112, the material database 113, the printing means 114, the order details input means 115, the charging means 116, and the like shown in FIG. 16 are the same as those shown in FIG. 1. Thus, the descriptions thereof are omitted.

The image data assigning means 121 assigns image data to be printed out to each image output apparatus 103 (each printer). The image data is assigned, for example, by (1) assigning the image data equally to all printers to complete printing as quickly as possible, (2) preferentially assigning the image data to a printer with a large amount of printing materials, (3) assigning the same images to the same printer, (4) causing a certain printing device to be used more frequently than other printing devices, (5) any combination (1) to (4), above.

The communication means 122 controls the transfer of various information between the image output apparatus 103. The communication means 122 performs transferring and receiving of assigned image data and transmitting and receiving of printing requests between the image output apparatus 103.

The printed item conveying means 123 conveys printed items between the image output apparatus 103 (between removal openings). The printed item conveying means 123 is, for example, a belt conveyer. The printed item conveying means 123 conveys printed items to the image output apparatus (removal opening) having requested the printing (apparatus having received the order).

The network (connection line) 105 is a network, a connection line, or the like. The network can be a local area network (LAN), a dedicated circuit, the Internet, etc. The connection line can be a cable, a bus, etc. The network (connection line) may be wired or wireless. The network (connection line) 105 mediates the transfer of data between the image output apparatus 103.

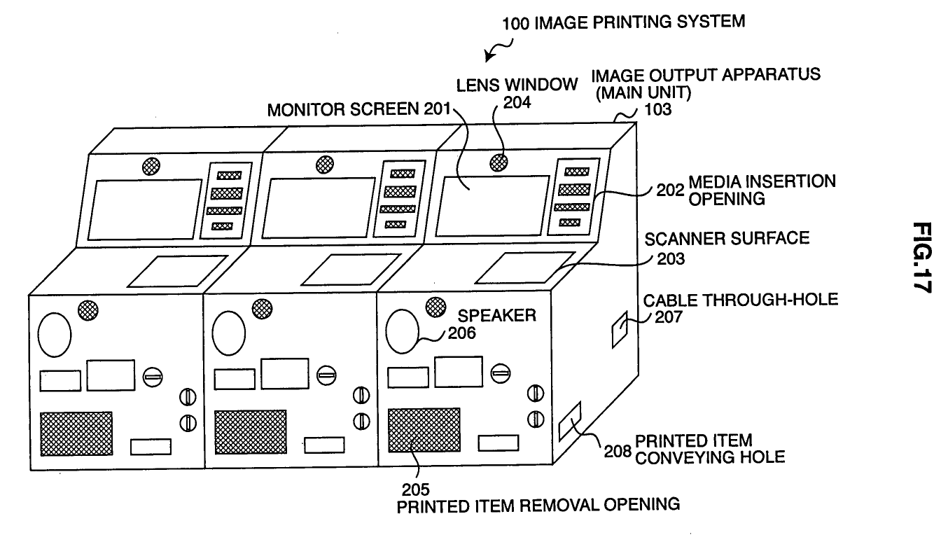

Next, the external and internal structures of the image printing system 100 (image output apparatus 103) is described with reference to FIG. 17 to FIG. 19.

FIG. 17 is the outer perspective view of the image printing system 100 (the image output apparatus 103).

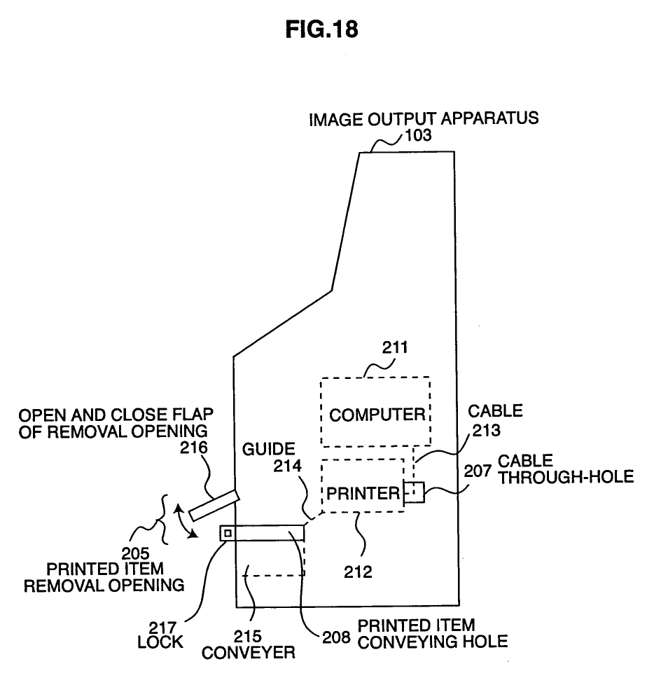

FIG. 18 is the side view of the image printing system 100 (the image output apparatus 103).

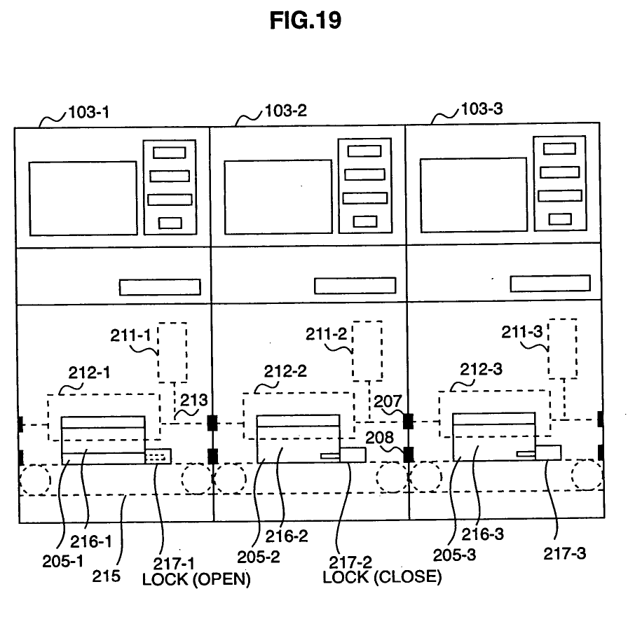

FIG. 19 is the front view of the image printing system 100 (the image output apparatus 103).

In the image printing system 100 shown in FIG. 17 to FIG. 19, a plurality of image output apparatus 103 are connected and positioned next to each other.

The monitor screen 201, the media insertion opening 202, the scanner surface 203, the lens window 204, the printed item removal opening 205, the speaker 206 etc. in FIG. 17 are the same as those shown in FIG. 2. Thus, the descriptions thereof are omitted.

A cable through-hole 207 is a through-hole for leading cables, etc. that connect the image output apparatus 103 with each other and is provided on the side surface, etc. of the image output apparatus 103.

A printed item conveying hole 208 is a conveying hole to pass printed items being conveyed between the image output apparatus 103 and is provided on the side surface, etc. of the image output apparatus 103. In addition, although not shown here, a hole to pass the belt of a conveyer that conveys printed items can also be provided on the side surface, etc. of the image output apparatus 103.

In addition, a computer 211 (211-1, 211-2, 211-3 . . . ) that includes a control section for controlling respective constituent parts, a printer 212 (212-1, 212-2, 212-3 . . . ) for performing printout, the connection line 213, such as a cable, etc. for connecting the image output apparatus 103, a power supply box for performing voltage conversion (not shown), an uninterruptible power source device for preventing damage to a CPU and a hard disk (not shown), etc. of the control section are disposed in the main unit of each image output apparatus 103.

Printed items printed out by the printer 212 are sent to a conveyer 215 via a guide 214.

The conveyer 215 is a conveyer, etc. for conveying printed items between the image output apparatus 103 and conveying the printed items to a predetermined printed item removal opening 205.

The printed item removal opening 205 includes a removal opening open and close flap 216 and can be opened or closed individually using a lock 217.

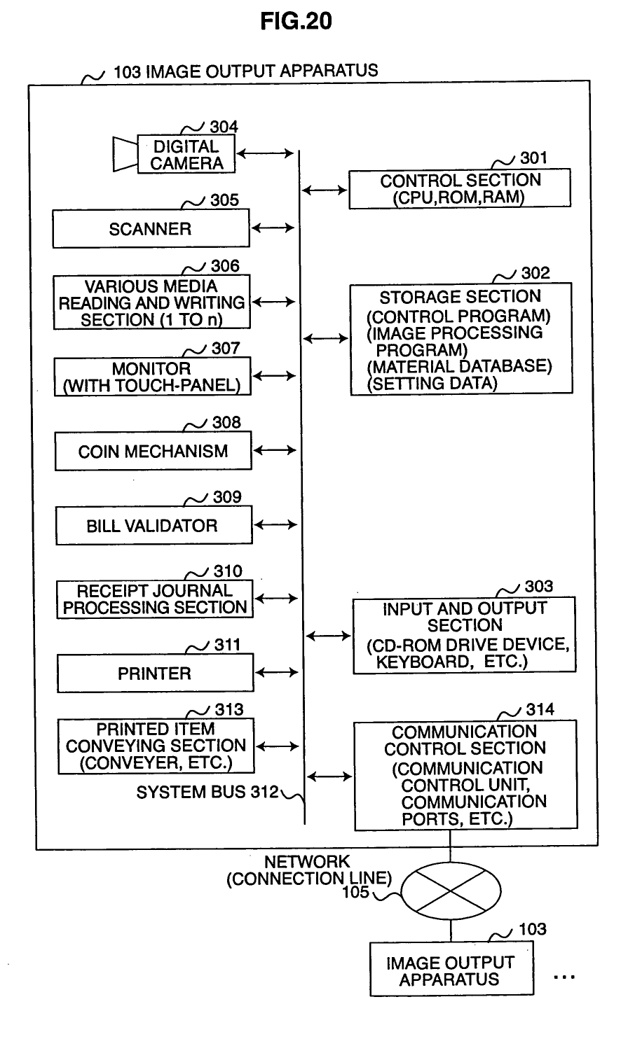

Next, the hardware configuration of the image output apparatus 103 is explained with reference to FIG. 20.

FIG. 20 is the hardware configuration diagram of the image output apparatus 103.

In the image output apparatus 103, a control section 301, a memory section 302, an input and output section 303, a digital camera 304, a scanner 305, various media reading and writing sections 306 (1 to n), a monitor 307 (with a touch-panel), a coin mechanism 308, a bill validator 309, a receipt journal processing section 310, a printer 311, a printed item conveying section 313, a communication control section 314, and the like are connected via a system bus 312.

The control section 301, the memory section 302, the input and output section.303, the digital camera 304, the scanner 305, the various media reading and writing sections 306 (1 to n), the monitor 307 (with a touch-panel), the coin mechanism 308, the bill validator 309, the receipt journal processing section 310, the printer 311, the system bus 312, etc. in FIG. 20 are the same as those shown in FIG. 3. Thus, the descriptions thereof are omitted.

The printed item conveying section 313 conveys printed items to the predetermined printed item removal opening. In addition, the printed item conveying section 313 removes the printed item from the belt conveyer at the removal opening to which the printed item have been conveyed and feeds the printed item to the removal opening.

In addition, the printed item conveying section 313 opens (unlocks) the open and close flap of the removal opening to which the printed items have been conveyed so that the printed item can be removed, and closes (locks) the open and close flaps of the other removal openings so that these openings cannot be used.

The communication control section 314 includes a communication control unit, communication ports, etc., and performs transmission control between the image output apparatus 103.

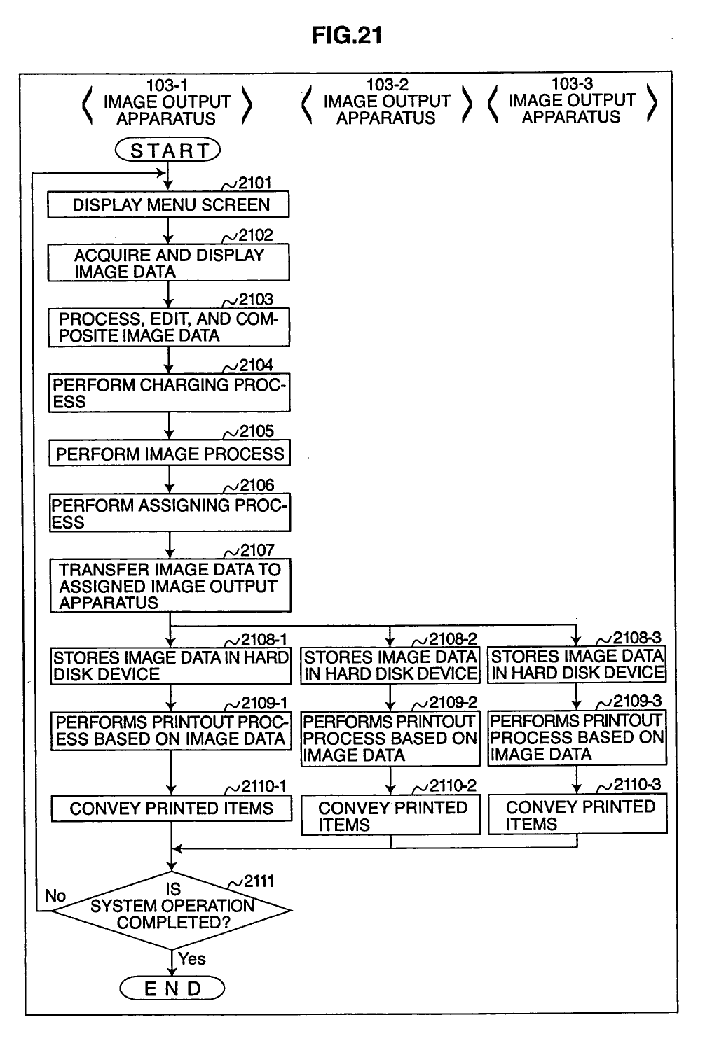

Next, an operation of the image printing system 100 (image output apparatus 103) is described with reference to FIG. 21.

FIG. 21 is a flowchart showing the operation of the image output apparatus 103.

The image output apparatus 103 (control section 301) displays a menu screen showing service details, procedures, guides, and the like and requests that the user make selections (Step 2101).

The image output apparatus 103 acquires image data and displays the image data on the monitor (Step 2102). When inputting image data, the user can select a method, such as reading the image data from a recording media, reading from a scanner, or photographing a subject by an imaging device (digital camera and the like).

The image output apparatus 103 performs processing, editing, compositing, etc. of the image data based on instructions from the user (Step 2103). Processing, editing, and compositing of the image are, for example, compositing input image data together, compositing with a frame image, compositing with existing images and the like, coloring, inputting text, moving, enlarging and reducing, creating postcard data and the like.

The image output apparatus 103 performs a charging process and a receipt issuing process according to the details of the user's order (output mode (photograph print, sticker print, index print, postcard print, etc.), number of prints, and the like) (Step 2104).

The image output apparatus 103 performs image processes such as color correction, resizing, trimming, layout, text and logo composition (Step 2105).

The image output apparatus 103 assigns image data to be printed out to respective image output apparatus 103 (respective printers) (Step 2106), transfers the image data to the respective assigned image output apparatus 103 (each printer), and requests printout of the image data (Step 2107).

Each image output apparatus 103 holds the image data in the memory, the hard disk device., or the like (Step 2108-1, Step 2108-2, Step 2108-3 . . . ), transfers the image data to the printer device which is in an output-ready state, and performs the printout process (Step 2109-1, Step 2109-2, Step 2109-3 . . . ).

Each image output apparatus 103 conveys the printed item (printouts) to the printed item removal opening of the image output apparatus 103 having requested the printing, using a belt conveyer and the like (Step 2110-1, Step 2110-2, Step 2110-3 . . . ).

When continuing the operation of the image printing system 100 (No, in Step 2111), the image output apparatus 103 repeats the processes in Step 2101 to Step 2111.

Through the above-mentioned processes, the image output apparatus 103 assigns image data to be printed out to a plurality of image output apparatus 103 (printers), transfers the corresponding image data to the individual image output apparatus (printers), and requests printout of the image data. The image output apparatus 103 (printers), having received the request for image data printout, prints out the transferred image data and conveys the printed item to the image output apparatus 103 having requested the printing (printed item removal opening).

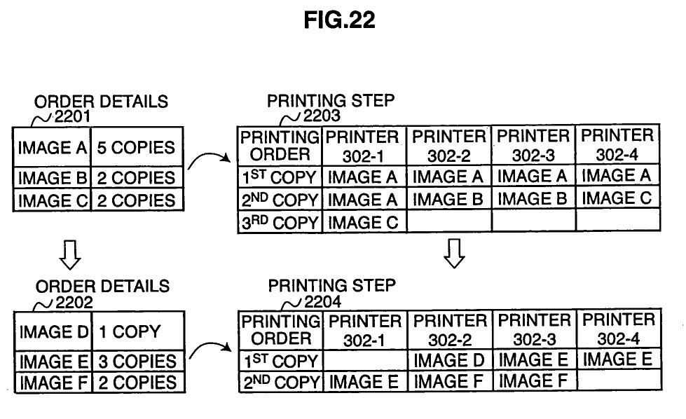

Next, the processing steps of the image output apparatus 103 related to an assigning process (FIG. 21: Step 2106) are described with reference to FIG. 22 to FIG. 26.

The following descriptions are made under the assumption that, in addition to receiving orders for image data printout and performing the printout process itself, the image output apparatus 103-1 (printer 212-1) assigns image data to other image output apparatus 103-2 to 103-4 (printer 212-2 to 212-4), and requests image data printout, as required.

FIG. 22 to FIG. 26 are diagrams showing order details and printing steps.

As shown in FIG. 22, the first order details 2201 is “image A (5 copies), image B (2 copies), and image C (2 copies)”. The next order details 2202 is “image D (1copy), image E (3 copies), and image F (2 copies)”.

First, when the order details 2201 is received, the image output apparatus 103-1 assigns “image A (2 copies) and image C (1 copy)” to the printer 212-1, “image A (1 copy) and image B (1 copy)” to the printer 212-2, “image A (1 copy) and image B (1 copy)” to the printer 212-3, and “image A (1 copy) and image C (1 copy)” to the printer 212-4. The image output apparatus 103-1 to 103-4 (printer 212-1 to 212-4) perform the image data printout process in a printing step 2203.

Next, when the order details 2202 is received, the image output apparatus 103-1 assigns “image E (1 copy)” to the printer 212-1, “image D (1 copy) and image F (1 copy)” to the printer 212-2, “image E (1 copy) and image F (1 copy)” to the printer 212-3, and “image E (1 copy)” to the printer 212-4. The image output apparatus 103-1 to 103-4 (printer 212-1 to 212-4) perform the image data printout process in a printing step 2204.

As described above, when order details are received, the image output apparatus 103-1 preferentially assigns the image data to printing devices in ascending order of the number of printed image data.

Therefore, the operation rates of printers are almost equal even after repeated printing orders, and the amounts of remaining printing materials do not differ between printers. Thus, situations where the timings for replenishing printing materials vary and certain printers (for example, the printer 212-1) are more frequently used, thereby leading to failure, etc., can be avoided.

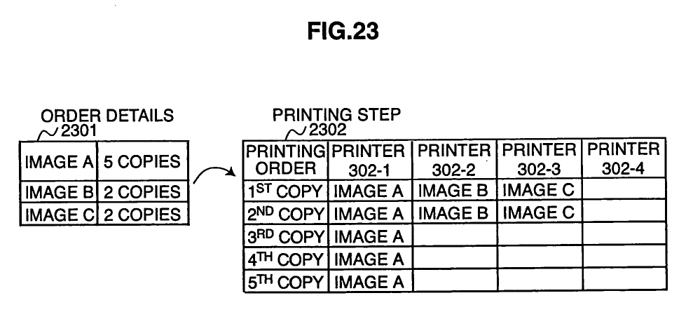

As shown in FIG. 23, order details 2301 is “image A (5 copies), image B (2 copies), and image C (2 copies)”.

When the order details 2301 is received, the image output apparatus 103-1 assigns “image A (5 copies)” to the printer 212-1, “image B (2 copies)” to the printer 212-2, and “image C (2 copies)” to the printer 212-3. The image output apparatus 103-1 to 103-3 (printer 212-1 to 212-3) perform the image data printout process in a printing step 2302.

As described above, when order details are received, the image output apparatus 103-1 assigns the same image data to the same image output apparatus (printer).

Therefore, the same image data are printed by the same printer, and thus, situations where the reproducibility of colors and tones may differ due to differences between individual printers, differences between printing material lots, etc., can be avoided.

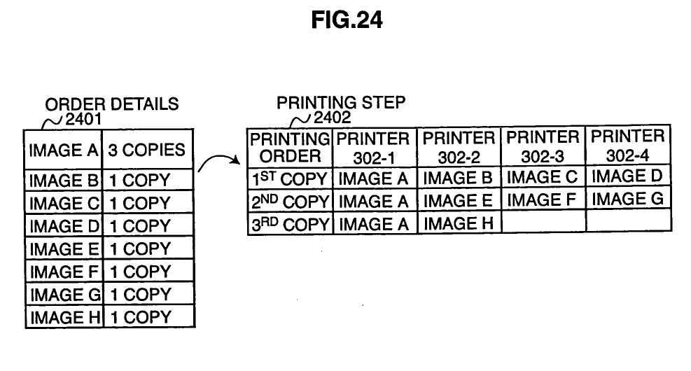

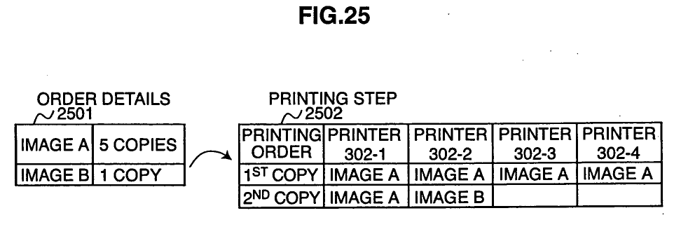

As a variation of FIG. 23, when the number of printouts required is sufficiently large, as shown-in order details 2401 in FIG. 24, the image A is assigned to one printer, as shown in a printing step 2402 in FIG. 24, and other images are assigned to other printers (can include the printer to which image A is assigned) so that the number of copies assigned to the other printers is the same or one copy less than the plural copies of the image A assigned to the printer, as in, for example FIG. 23. Meanwhile, when only the number of copies of the image A to be printed is extremely large, as shown in order details 2501 in FIG. 25, a method where-the image data are assigned as shown in a printing step 2502 as in FIG. 22 and the total printing time is minimized can be used.

In addition, for example, when printing 20 copies of image G, the printing time is extremely long if all of the copies are assigned to one printer (image output apparatus). In this case, a threshold can be set, and copies exceeding the threshold can be assigned to other printers (image output apparatus). In this case, if the threshold is 15 copies, 15 copies of image G are assigned to the printer 212-1 and 5 copies of image G are assigned to the printer 212-2.

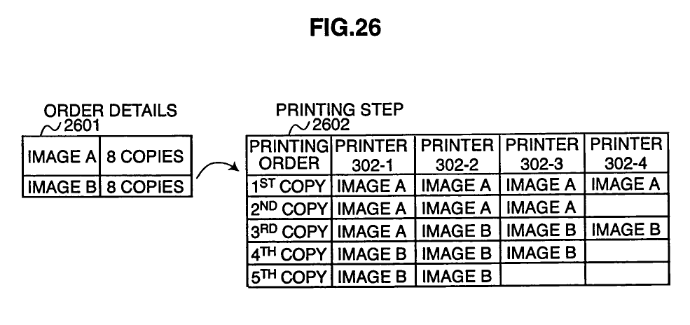

As shown in FIG. 26, order details 2601 is “image A (8 copies) and image B (8 copies)”.

When receiving the order details 2601, the image output apparatus 103-1 assigns “image A (3 copies) and image B (2 copies)” to the printer 212-1, “image A (2 copies) and image B (3 copies)” to the printer 212-2, “image A (2 copies) and image B (2 copies,)” to the printer 212-3, and “image A (1 copy) and image B (1 copy)” to the printer 212-4. The image output apparatus 103-1 to 103-4 (printer 212-1 to 212-4) perform the image data printout process in a printing step 2602.

As described above, when order details are received, the image output apparatus 103-1 assigns the image data so that the operation rate of the printer 212-4 is smaller than those of the other printers (for example, 50% of the operation rates of other printers).

Thus, situations where the printing materials in all of the printers are depleted almost simultaneously, thereby stopping the entire system, can be avoided.

The image output apparatus may be configured to equally assign image data to all printers until a certain number of copies are printed, and then assign the image data so that the operation rate of a certain printer becomes smaller than those of the other printers.

In addition, when the printing materials of individual printers will be depleted can be calculated based on the numbers of already-printed copies, and the operation rates of individual printers can be adjusted so that the printing materials of individual printers are depleted with a certain amount of time lag (for example, the time lag between the depletion of printing materials in one printer and that in another printer is two days).

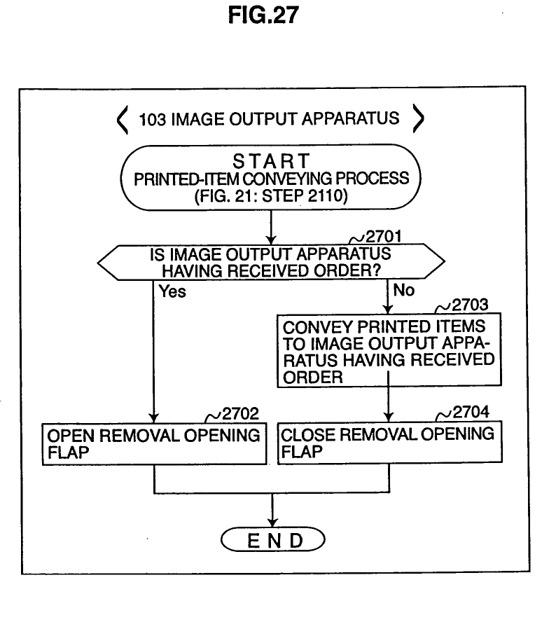

Next, an operation of the image output apparatus 103 related to the printed item conveying process is described with reference to FIG. 27.

FIG. 27 is the flowchart showing the operation of the image output apparatus 103 related to the printed item conveying process.

The following descriptions are made under the assumption that, in addition to receiving orders for image data printout and performing the printout process itself, the image output apparatus 103-1 (printer 212-1) assigns image data to other image output apparatus 1.03-2 to 103-3 (printer 212-2 to 212-3), and requests image data printout, as required (see FIG. 17 to FIG. 19).

If the image output apparatus 103 is the apparatus having requested the printing (apparatus having received the order) (Yes, in Step 2701), the image output apparatus 103 releases the lock 217 of the open and close flap 216 of its own printed item removal opening 205 (Step 2702). If the image output apparatus 103 is not the apparatus having requested the printing (apparatus having received the order) (No, in Step 2701), the image output apparatus 103 conveys the printed items to the image output apparatus (printer) having requested the printing (apparatus having received the order) using the conveyer 205 (Step 2703), and locks the lock 217 of the open and close flap 216 of its own printed item removal opening 205 (Step 2704).

As described above, the image output apparatus 103-1 (printer 212-1) releases the lock 217-1 of the open and close flap 216-1 of its own printed item removal opening 205-1.

On the other hand, the other image output apparatus 103-2 and 103-3 (printer 212-2 and 212-3) convey printed items to the image output apparatus 103-1 (printer 212-1) having requested the printing (apparatus having received the order) using the conveyer 215 and lock the lock 217-2 of the open and close flap 216-2 of the printed item removal opening 205-2 and the lock 217-3 of the open and close flap 216-3 of the printed item removal opening 205-3, respectively.

Therefore, even if image data are assigned to a plurality of printers, the user can remove printed items from one printed item removal opening. Thus, the workload placed on the user can be reduced and mix-ups between the user's printed items and those of others can be prevented.

As described above, according to the third embodiment of the present invention, the image output apparatus assigns image data to be printed out to a plurality of image data output apparatus (printers) using predetermined assigning methods (for example, (1 ) equal assignment of image data, (2) preferential use of printers with large amounts of remaining printing materials, (3) assignment of the same image to the same printer, (4) causing a certain printing device to be used more frequently than other printing devices, (5) any combination of (1 ) to (4), above, and the like). Thus, efficient, high-quality, high-speed image printout can be performed, and in addition, maintenance load can be reduced. In addition, the image output apparatus (printer) receiving a printout request prints out the transferred image data and conveys the printed item to the image output apparatus (printed item removal opening) requesting printout using a belt conveyer, etc. Thus, the workload placed on the user can be reduced and mix-ups between the user's printed items and those of others can be prevented.

In FIG. 17 to FIG. 19, explanations are made under the assumption that each image output apparatus 103 includes one computer, one printer, and the like. However, when one computer controls the operations of a plurality of image output apparatus, not all image output apparatus necessarily need to include computers. In addition, one image output apparatus can include a plurality of printers (for example, one printer for sticker prints, one printer for normal prints, etc.).

In addition, the image output apparatus can include each means (FIG. 16, etc.) and each apparatus (FIG. 20, etc) integrally, or a portion thereof can be separated and connected by a connection line (cable or the like, which may be wired or wireless), a network (dedicated line, LAN, the Internet, etc., which may be wired or wireless)., etc.

In addition, programs for performing the processes shown in FIG. 21 to FIG. 27 can be held in a recording medium such as a CD-ROM and distributed, or these programs can be transmitted and received via a communication circuit.

Although the preferred embodiments of the image output apparatus and the like according to the present invention have been described above, with reference to the attached drawings, the present invention is not limited to these examples. It is clear that various alternative embodiments and modifications falling within the scope of technical ideas disclosed in the present application are conceivable by persons skilled in the art, and it is understood that these alternative embodiments and modifications also fall within the technical scope of the present invention.

1. An image output apparatus comprising:
input element for inputting an image data from a recording medium;
output element for printing out the image data;
temporary storage element for reading non-displayed image data from the recording medium and holding the non-displayed image data in a temporary storage section with holding already-displayed image data; and
display element for reading image data from the temporary storage section and displaying the read image data.

2. An image output apparatus according to claim 1, wherein the temporary storage element holds the image data in the temporary storage section or deletes the image data from the temporary storage section, according to an order of priority and a predetermined limitation.

3. An image output apparatus according to claim 2, wherein the priority order of non-displayed image data for the next display screen is set higher than those of other non-displayed image data.

4. An image output apparatus according to claim 2, wherein the priority order of non-displayed detailed image data or non-displayed simplified image data corresponding to a selected already-displayed image data or an already-displayed image data in the vicinity thereof is set higher than those of other non-displayed image data.

5. An image output apparatus according to claim 2, wherein the predetermined limitation is set by specifying at least one of the maximum holding number of already-displayed image data or non-displayed image data and the maximum storage amount.

6. An image output apparatus comprising:
input element for inputting an image data from a recording medium;
temporary storage element for holding in a temporary storage section an image data that has been designated to be printed out; and
output element for reading the image data from the temporary storage section and printing out the read image data.

7. An image output apparatus according to claim 6, wherein when printout is designated from a list display, the temporary storage element reads image data to be printed out from the recording medium in advance before start of a printout process, and holds the image data in the temporary storage section.

8. An image output apparatus according to claim 6, wherein the temporary storage element holds the image data in the temporary storage section or deletes the image data from the temporary storage section, according to a predetermined limitation.

9. An image output apparatus according to claim 8, wherein the predetermined limitation is set by specifying at least one of the maximum holding number of image data and the maximum storage amount.

10. An image output apparatus according to claim 8, wherein the predetermined limitation is calculated on the basis of the capacity of the temporary storage section or the number of the printing devices.

11. An image display method performed by an image output apparatus that prints out image data read out from a recording medium, comprising:
reading non-displayed image data from the recording medium and holding the non-displayed image data in a temporary storage section with holding already-displayed image data; and
reading an image data from the temporary storage section and displaying the read image data.

12. An image display method performed by an image output apparatus that prints out image data read out from a recording medium, comprising:
holding in a temporary storage section image data that is designated to be printed out; and
reading the image data from the temporary storage section and printing out the read image data.

13. An image output apparatus comprising:
input element for inputting an image data from a recording medium;
display condition specifying element for displaying selection items for each display condition and specifying the display condition through selection of a selection item;
display element for displaying the image data based on the display conditions; and
output element for printing out the image data.

14. An image output apparatus according to claim 13, wherein the display condition specifying element displays at least one representative image data matching the display conditions, while relating it to the selection item.

15. An image output apparatus according to claim 13, wherein the display condition specifying element displays at least one representative image data matching the display conditions, while relating it to the selection item, and switches the representative image data.

16. An image output apparatus according to claim 13, wherein the display condition specifying element displays information regarding the image data matching the display conditions, while relating it to the selection item.

17. An image output apparatus according to claim 13, wherein the display conditions include at least one of date, year, month, week, time of photographing or creation of the image data.

18. An image output apparatus according to claim 13, wherein the selection items are displayed on a calendar

19. An image display method performed by an image output apparatus that prints out image data read out from a recording medium, comprising:
(a) displaying selection items for each display condition and specifying the display condition through selection of a selection item; and
(b) displaying the image data based on the display conditions.

20. An image display method according to claim 19, wherein the step (a) displays at least one representative image data matching the display conditions, while relating it to the selection item.

21. An image display method according to claim 19, wherein the step (a) displays at least one representative image data matching the display conditions, while relating it to the selection item, and switches the representative image data.

22. An image output apparatus comprising:
input element for inputting image data;
printing element for printing out image data using a plurality of printing devices; and
assigning element for assigning the image data to the plurality of printing devices, where the assigning element preferentially assigns the image data to be printed to the printing device that has printed out the least number of image data.

23. An image output apparatus comprising:
input element for inputting image data;
printing element for printing out image data using a plurality of printing devices; and
assigning element for assigning the image data to the plurality of printing devices, where the assigning element assigns the same image data to the same printing device.

24. An image output apparatus comprising:
input element for inputting image data;
printing element for printing out the image data using a plurality of printing devices; and
assigning element for assigning the image data to the plurality of printing devices, where the assigning element assigns a smaller percentage of image data to a certain printing device than to other printing devices.

25. An image output apparatus comprising:
input element for inputting image data;
printing element for printing out the image data using a plurality of printing devices;
assigning element for assigning the image data to the plurality of printing element;
a plurality of removal openings corresponding to the printing devices; and
a printed item conveying device for conveying printed items to a predetermined removal opening.

26. An image output apparatus according to claim 25, further comprising removal-opening open close element for opening an open and close flap of the predetermined removal opening and closing those of all other removal openings.

27. An image output method performed by an image output apparatus that prints out inputted image data, comprising:
printing out image data using a plurality of printing devices;
assigning the image data to the plurality of printing devices; and
conveying printed items to a predetermined removal opening among removal openings provided for respective printing devices.

28. (canceled)

29. (canceled)

30. A program which causes a computer to function as the image output apparatus according to claim 1.

31. A program which causes a computer to function as the image output apparatus according to claim 6.

32. A program which causes a computer to function as the image output apparatus according to claim 13.

33. A program which causes a computer to function as the image output apparatus according to claim 22.

34. A program which causes a computer to function as the image output apparatus according to claim 23.

35. A program which causes a computer to function as the image output apparatus according to claim 24.

36. A program which causes a computer to function as the image output apparatus according to claim 25.

37. A recording medium on which is recorded a program which causes a computer to function as the image output apparatus according to claim 1.

38. A recording medium on which is recorded a program which causes a computer to function as the image output apparatus according to claim 6.

39. A recording medium on which is recorded a program which causes a computer to function as the image output apparatus according to claim 13.

40. A recording medium on which is recorded a program which causes a computer to function as the image output apparatus according to claim 22.

41. A recording medium on which is recorded a program which causes a computer to function as the image output apparatus according to claim 23.

42. A recording medium on which is recorded a program which causes a computer to function as the image output apparatus according to claim 24.

43. A recording medium on which is recorded a program which causes a computer to function as the image output apparatus according to claim 25.
